(19) United States
(12) Patent Application Publication
(10) Pub. No.: US 2016/0319761 A1
(43) Pub. Date: Nov. 3, 2016

(54) Engine Warning Audio Visual System

(71) Applicant: Mason Kwok Yu, JR., Newark, NJ (US)

(72) Inventor: Mason Kwok Yu, JR., Newark, NJ (US)

(21) Appl. No.: 15/061,823

(22) Filed: Mar. 4, 2016

(51) Int. Cl. F02D 41/22; G07C 5/00; B60Q 9/00

(52) U.S. Cl. CPC F02D 41/22; B60Q 9/00; G07C 5/008; F02D 2041/228

(57) ABSTRACT

Novelty will assist the vehicle driver to find out more on the malfunction of the engine component. The system will give both audio and visual communication to the driver and forward engine codes and messages to the smartphone, tablet, smart watch. The same messages will be forwarded to the local car dealer as well. The Internet will be used to distribute these engine warning messages.

### TECHNICAL FIELD

Class 701 (Vehicle) 29.1+Diagnosis and maintenance A P 9

### CROSS REFERENCE TO RELATED APPLICATIONS

None.

### STATEMENT REGARDING FEDERALLY SPONSORED RESEARCH OR DEVELOPMENT

This invention did not acquire or need any federal sponsorship for research or development.

### SEQUENCE LISTING

None. This novelty does not pertain to anything to biology or biotechnology.

### BACKGROUND OF THE INVENTION

The invention is extremely simple in concept—what has been the standard issue in all operating cars and motor vehicles is the engine light which goes on the dashboard. This is extremely not very useful to the driver of the vehicle. This invention takes advantage of the underlying engine codes and through the use of the real-time operating system of the vehicle display a series of meaningful engine diagnostic messages in English on the touchscreen console and through the audio channel, i.e., through the car stereo system, audio diagnostic messages.

### BRIEF SUMMARY OF THE INVENTION

The deployment of the invention involves customization of the RTAOS (real-time automotive operating system). In most modern cars today, there is a computer chip which governs the operation of the vehicle. The invention calls for the encapsulation of the various engine codes and the contextual meaning of the engine codes in English stowed in NVRAM.

### NUMBERING OF SHEETS OF DRAWINGS AND VIEWS

FIG. 1—Exterior Frame of Typical Car with Dashboard. This is a wireframe of a typical wireframe structure of a four wheeled vehicle. Detached to the northwest of this wireframe structure is a typical automobile dashboard, speedometer, odometer, fuel gauge that a driver would monitor during the course of driving. Also, there is a touchscreen located in the center console.

FIG. 2—This is a nominal dashboard with the typical instrumentation of what a driver's line of sight provides. Beyond the steering column, there is the tachometer, speedometer, oil gauge, fuel gauge, oil gauge, radiator temperature.

FIG. 3—This is the same figure as FIG. 2 only that an engine component has failed and the engine light has come on. The lighted icon is visible on the vehicle dashboard and will not clear until the driver brings the vehicle to a local auto repair facility and the car be diagnosed electronically.

FIG. 4—This is the same vehicle dashboard layout as FIGS. 2 and 3, except the novelty of invention is depicted with the engine warnings in English as well as a brief description of the failing engine component.

FIG. 5—This is a basic overview of the novelty. There are two ways in which the driver of the vehicle will be informed. First is the via the visual means. The second is via the audio channel of the automobile, namely through the speakers for the radio and stereo.

FIG. 6—This schematics shows the logical extension to the invention. The engine warnings and diagnostics can be propagated to Internet devices-Smartphones, tablets and/or smart watches. The engine diagnostics and warnings can also be sent to the local dealership/auto repair shop.

FIG. 7—The cars which have this novelty will be able to forward this information and a database of engine codes by model and severity can be accumulated. Depending on the make and model of the vehicle, there are hundreds of dealerships across continental United States.

FIG. 8—This is a hardware and software schematic depicting the implementation and realization of the invention.

FIG. 9—This is the sequence diagram showing how control is passed. There are two numbers x—y. This means control is being passed from component x to component y. The individual numbers from 1, 2, . . . , 14 refer to the components enumerated in FIG. 8.

FIG. 10—This figure depicts the heart of this system, the real-time automotive operating system. The database key is the engine warning code.

FIG. 11—This is an optional way to read the database of engine codes. Instead of using NVRAM exclusively during the operation of the vehicle, during the initial load of the RTAOS, the contents of the NVRAM are loaded into RAM. From that point on, the in-memory database of engine codes and warning messages are used for lookups. The message lookup table is the mirror image of the NVRAM chip. Architecturally, this is the persistence layer.

FIG. 12—This is a more detailed column structure of the NVRAM on English.

FIG. 13—This is the French equivalent to the English NVRAM.

FIG. 14—This is the Spanish equivalent to the English NVRAM.

FIG. 15—This is the German equivalent to the English NVRAM.

FIG. 16—This is a typical prom blower (programmer).

FIG. 17—This is a schematic which shows a blank NVRAM which gets programmed with the specific engine warning messages for car model XYZ via the prom programmer.

FIG. 18—This is a schematic which shows a blank NVRAM which gets programmed with the specific engine warning messages for car model ABC via the prom programmer.

FIG. 19—A mass production facility for the NVRAM chips for a factory floor configuration for car model XYZ.

FIG. 20—This is a schematic showing the means in which the Customer Preference Table (CPT) is populated via the GUI session in English panels.

FIG. 21—This is a schematic showing the means in which the Customer Preference Table (CPT) is populated via the GUI session in French panels.

FIG. 22—This is a schematic showing the means in which the Customer Preference Table (CPT) is populated via the GUI session in Spanish panels.

FIG. 23—This diagram show the relationship of the life cycle of the CPT and the operation of the RTAOS.

FIG. 24—This diagram shows the relationship from the failing engine component through RTAOS and the NVRAM in English and processing the engine warning message via the forward processing module and then through the audio components.

FIG. 25—This diagram shows the relationship from the failing engine component through RTAOS and the NVRAM in French and processing the engine warning message via the forward processing module and then through the audio components.

FIG. 26—This diagram shows the relationship from the failing engine component through RTAOS and the NVRAM in Spanish and processing the engine warning message via the forward processing module and then through the audio components.

FIG. 27—This diagram shows the relationship from the failing engine component through RTAOS and the NVRAM in German and processing the engine warning message via the forward processing module and then through the audio components.

FIG. 28—This diagram shows the relationship from the failing engine component through RTAOS and the NVRAM in English and processing the engine warning message via the forward processing module and then through the emergency channel satellite adapter and the Mi-Fi wide area Internet adapter. The NVRAM table is also available in French and/or Spanish.

FIG. 29—Engine diagnostics can be disseminated via the smart glass wearable by the driver operator of the vehicle.

FIG. 30—RTAOS. NVRAM and the smart glass communications adapter

FIG. 31—Critical successful factors for implementation of novelty

FIG. 32—The engine warning/diagnostic messages can be texted or emailed to the car driver's smartphone, tablet and/or smartwatch. More importantly, these messages can be forwarded to the local car dealer repair facility. If the car is equipped with the emergency channel satellite communications adapter, the engine diagnostic messages can be forwarded to the 24 by 7 emergency call center. These messages can then be routed to the local car dealer repair center.

FIG. 33—Satellite communications link to emergency call center and car dealership repair center.

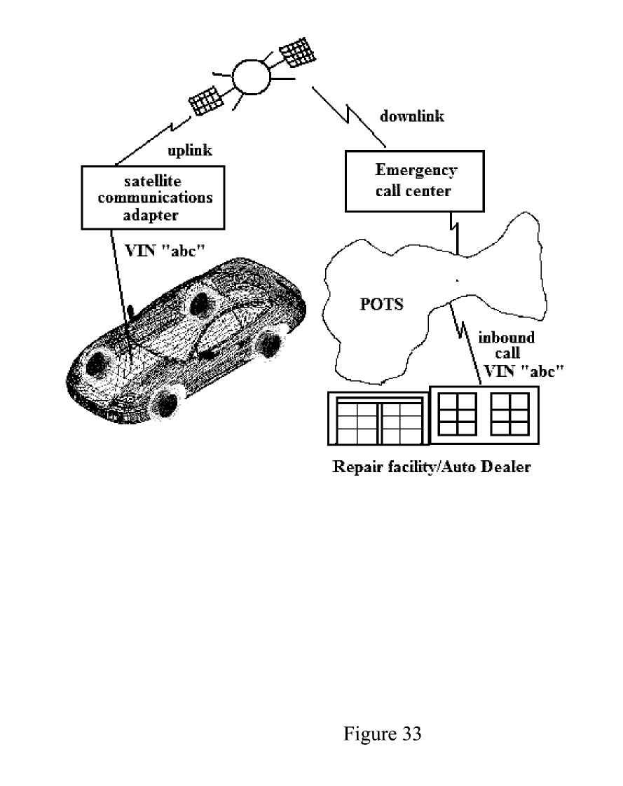

FIG. 34—A developer running iOS on the laptop can build the app from the sdk. The developer can then test the app locally and then upload the production grade app to the app store via the Internet.

FIG. 35—A developer running the Android Eclipse IDE can build the app from the sdk. The app can be tested locally on the tablet or smartphone. Once the app has been thoroughly tested, it can be uploaded to the app store via Internet.

FIG. 36—The car driver obtain the Apple app from the app store and download the app to the smart phone, tablet or smartwatch via the Internet.

FIG. 37—The car driver obtain the Android app from the app store and download the app to the smart phone, tablet via the Internet.

FIG. 38—This diagram shows the relationship from the failing engine component through RTAOS and the NVRAM in English and processing the engine warning message via the forward processing module and then through the heads up display adapter. The NVRAM is also available in French and/or Spanish.

FIG. 39—This is the result of the headsup display near the front windshield. The contents of the GUI include the engine warning messages and diagnostics.

FIG. 40—This is the initialization screen to set up the engine diagnostic messages.

FIG. 41—This is the second screen to select the mode of communication.

FIG. 42—This is the companion help screen to the mode of communication.

FIG. 43—This shows the relationship between FIG. 40 and FIG. 41.

FIG. 44—This is the 3^{rd} screen to select the means of audio communication.

FIG. 45—This is the 4^{th} screen to the mode of visualization.

FIG. 46—This is the 5^{th} screen to select the device for the Internet.

FIG. 47—This is the 6^{th} screen to select which operating system for the mobile device.

FIG. 48—The seventh screen is for the frequency of notification of engine warning messages in hours, minutes and seconds.

FIG. 49—The eighth screen is for selection of languages—English, French, German or Spanish.

FIG. 50—This is the composite navigational flow—GUI screens and the companion help screens.

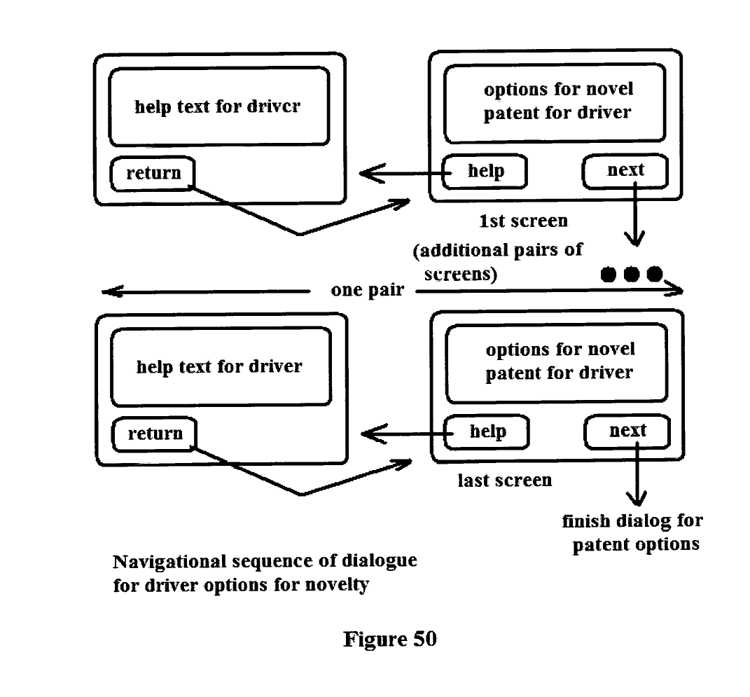

FIG. 51—This is the resultant screen—visualization onto the touchscreen. console.

FIG. 52—This is the big picture of the car, phone, tablet, smartwatch, PC, infortainment center—Internet of things (IOT).

FIG. 53—This is a schematic of the mobile app being downloaded from the Internet onto a driver's smartphone. This figure depicts subsequent steps of the driver registering as a user of the cloud computing storage service.

FIG. 54—This figure shows the communications link between the car, smartphone, cloud computer/storage service and the car repair facility.

FIG. 55—This figure shows the relationship of the car repair technician, engine diagnostic machine and the cloud compute storage service.

FIG. 56—This is the figure which shows the retrieval capability from the cloud computer storage service, mobile phone and the wireless setup with a local laser printer to obtain hardcopy of engine service records.

FIG. 57—Integration of the Internet of Things and the engine diagnostic/message service offering available on the public cloud.

FIG. 58—Big Data application with multiple cloud instances for different car model and make

### DETAILED DESCRIPTION OF THE INVENTION

The invention is extremely simple. Instead of having a yellowish/red warning light on the vehicle's dashboard, a combination of a short concise phrase will appear on the dashboard or on the touchscreen console. Undoubtedly, this is for the expressed benefit of letting the driver know what the problem is with the automobile. Also, an optional enhancement to reinforce the driver is to have this diagnostic message pipelined through the automobile's stereo or loudspeaker system. This diagnostic combination will serve as a comprehensive audio visual system to give the driver a 360 degree communication to the driver. Additional means of communication will include sending this diagnostic message to the driver's smartphone and/or tablet as well as an email sent to the driver with the specific notification and moreover, an email to the driver's carmaker or as backup the preferred auto repair shop in the driver's vicinity. Some vehicles have the facility to change the language to reflect the driver's native tongue—English, French, Spanish or German. Depending on the sophistication of the driver, the onboard computer software can be adjusted to reflect other languages as well—Russian, Italian, Dutch for the dashboard display and the corresponding audio enunciation of the automobile engine problem in the specific foreign language of driver choice.

### Technical Problem

For over 30 years since the 1980's, every car has had a mandatory OBD-II connector and when there is a specific problem with the engine component, only a warning light appears on the dashboard. The driver is absolutely clueless as to the severity and extent of the engine problem. There are typically over 400+ different codes available which are hidden or not totally transparent to the driver. The prior art does not have any facility to intelligently convey the engine warnings or ongoing problems.

### The Solution to the Problem

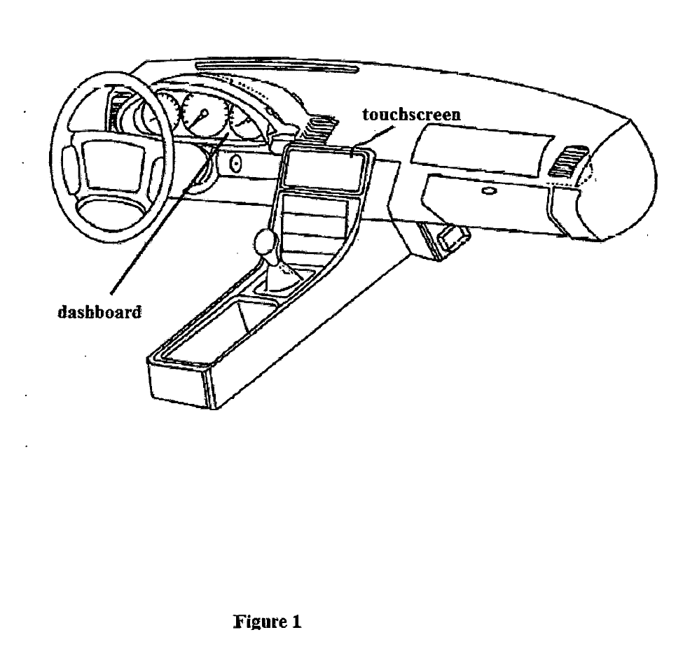

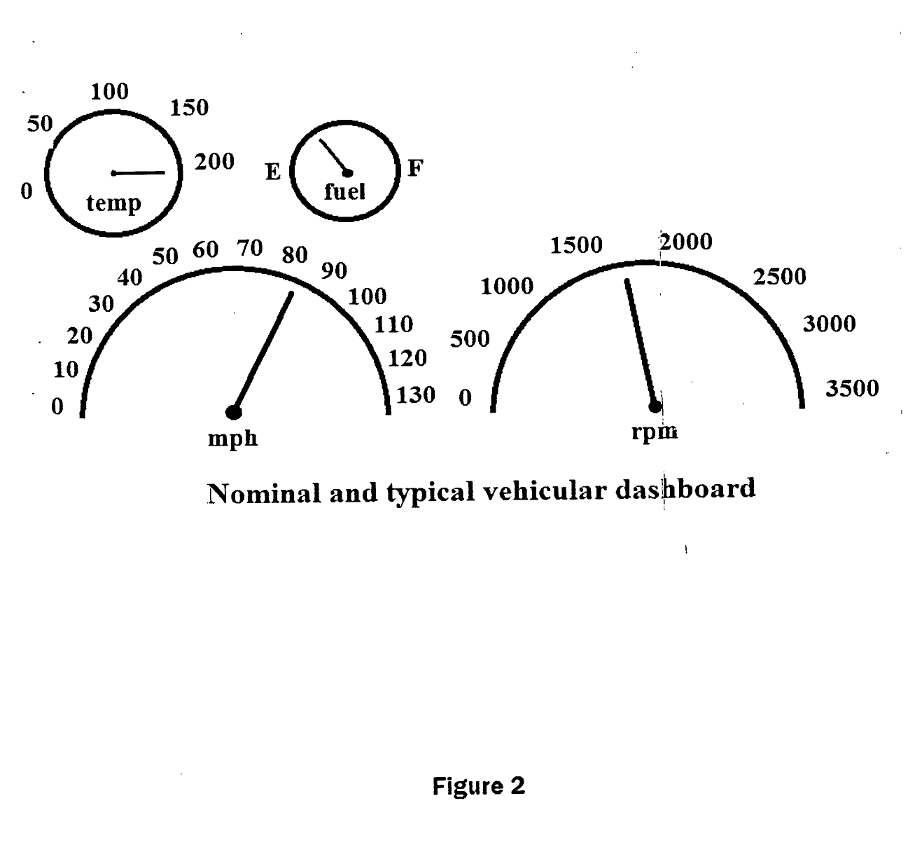

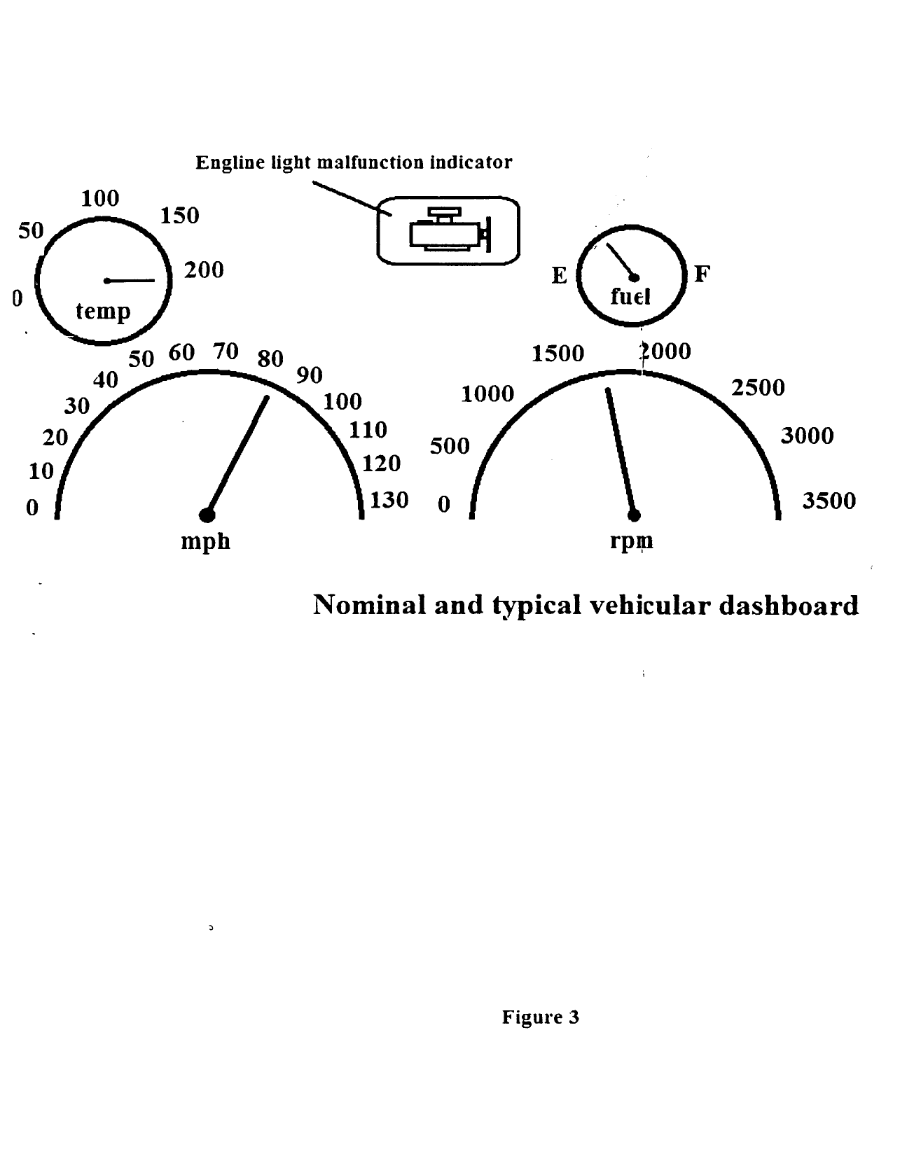

The solution to the problem will require a careful modification and of the RTAOS (real-time automotive operating system) as well as the available touchscreen on the center console usually between the driver and the front passenger seat. In FIG. 1, there is a nominal vehicle with four wheels. The car has a dashboard on the driver's side and a touchscreen. In FIG. 2, a typical vehicle dashboard consists of a speedometer, tachometer, fuel gauge, oil pressure gauge, temperature gauge of the radiator and the battery amperage level. Depending on the model and make of the car, the shape and location of each instrument will vary. The exact position and size for the novelty of the invention is dependent upon of the exact location of these other basic instruments. Depending on the condition of the car engine, driving habits, mileage and the due diligence of the car maintenance schedule, the failing engine component will occur, thus signaling the ubiquitous engine warning light to appear on the dashboard. Typically, once the engine warning light appears on the dashboard, there is no way to rid this irritating and yet important diagnostic feature of the car. This is universal among all the cars driven in the United States. Refer to FIG. 3 for the depiction of the engine warning light. The only way the Engine light does not appear is if the ignition of the car is turned off and the engine power is turned off. Unless the car is brought in to the local car dealer and the engine anomaly is rectified, the engine warning light will remain on the dashboard.¹ ¹ Cadillac Owners Manual, see URL in Non-patent Literature

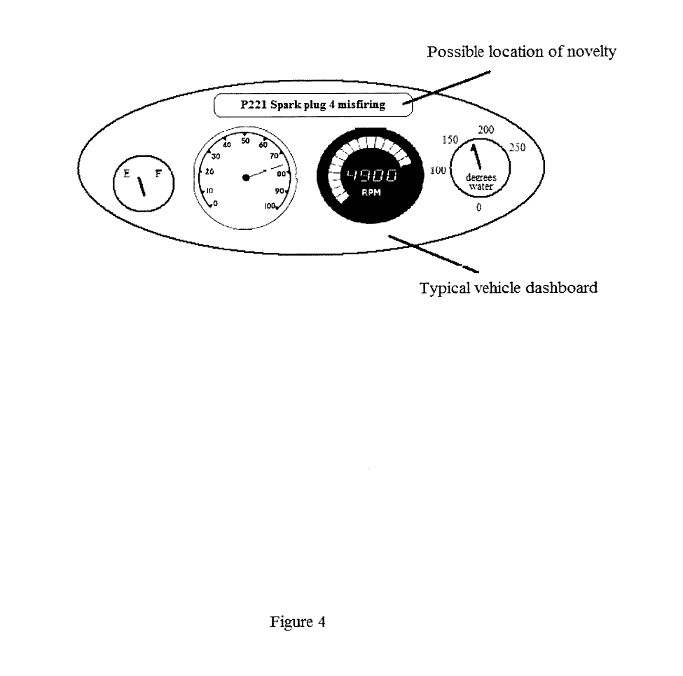

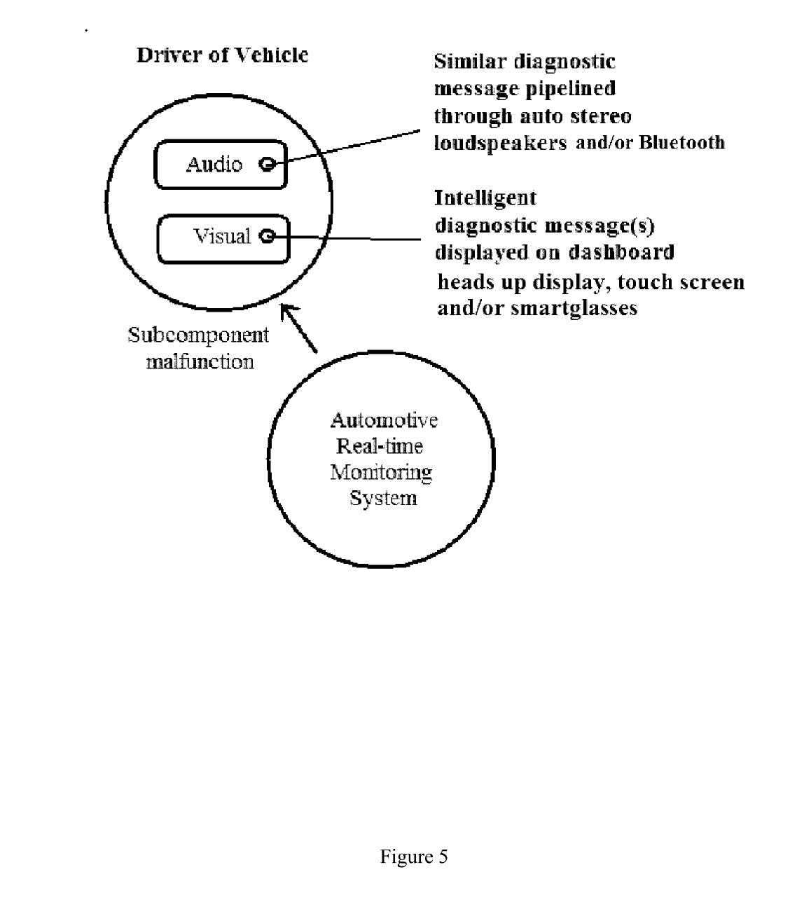

The solution to this problem is that the novelty is to have a descriptive English text appear onto the dashboard as to the specific engine component malfunction and the subcomponent problem. Nevertheless, though the engine component still needs to be serviced, however, the driver of the vehicle will have better information as to the nature of the engine component failure. The information presented can compel the driver to expedite the repair rather than looking at a non-descriptive light and indefinitely procrastinate on the pending auto engine repair. The location and font are really not relevant to novelty being presented. Refer to FIG. 4 for this description of the solution to the problem. The novelty goes beyond the conveyance of the engine warning text messages on the dashboard. Provided that the vehicle has a center console, a series of GUI panels can give the driver of the vehicle a choice of either audio and/or visual communication modes. The driver can have the specific engine diagnostic warning messages pipelined over the car stereo speakers or via a Bluetooth headset. The visualization of these engine diagnostic messages can appear on the center console or on the vehicle's futuristic heads up virtual display. Refer to FIG. 5 for this demarcation of functionality.

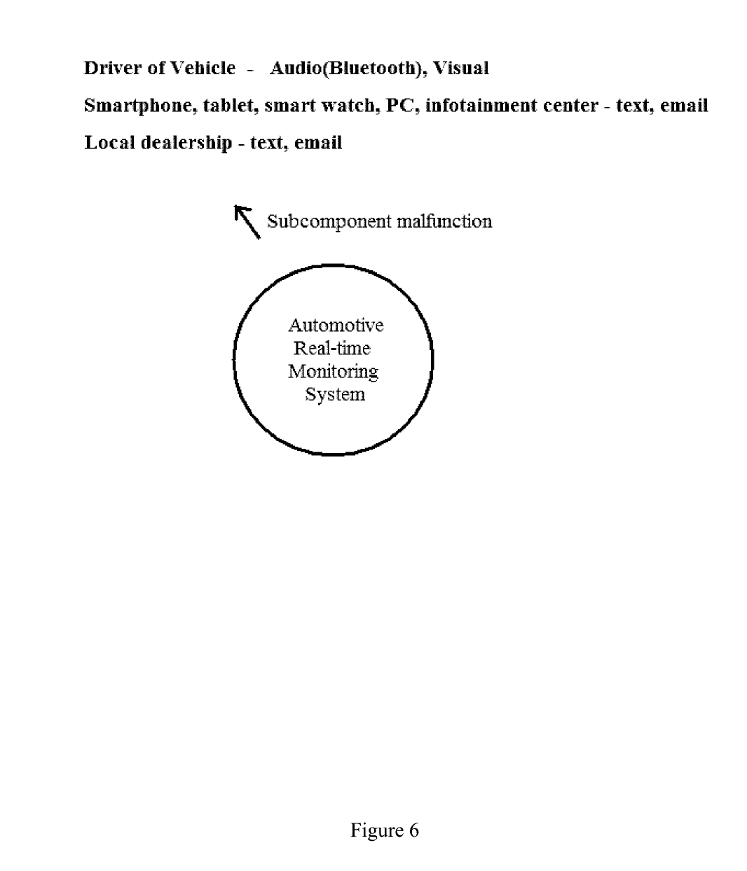

Furthermore, since in present day society is inundated with smartphones, tablets, PCs, infotainment² center and even smart watches, these engine diagnostic messages can be conceivably texted and/or emailed to the car owner. The email and text can also be forwarded to the local car dealership/repair facility. The car dealer can get an advance or preemptive notification of what is troubling with the car engine for that particular customer. The car dealer and the car owner can sync up nearly simultaneously before the car inspection. The car owner will have few surprises and this is what is known as preemptive knowledge. This enables the car owner of having advance knowledge, not just during normal operation, but an unprecedented way at being cognizant of engine anomalies. Refer to FIG. 6. ² See entry two, how to create a home entertainment center URL

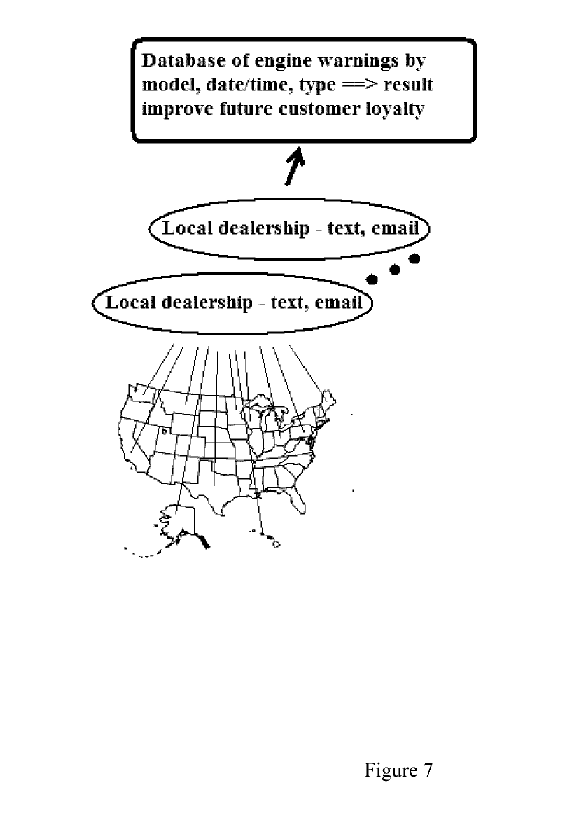

In the US, depending of the car make and model, there are hundreds of car dealerships from Alaska to Maine to Florida to Hawaii. Should a particular car division bring forth this invention into fruition, over a period of time, a database can be accumulated comprising of data, time, VIN, car make, car type, type of engine code. The information gathered here is priceless, since it gives which part of the engine component has the greatest frequency of failure. A natural and logical derivation is to calculate a statistical ranking and percentage of the engine component breakdowns. For the design engineer, this is equivalent to the ultimate feedback loop—to know which components have the greatest and least durability in real world driving conditions. These near real-time and “real world” statistics construe accurate mechanical and component failures. This is far more objective than to have to deal with a subjective customer complaint. For the design engineering team, it gives valuable perspective into what components need to be redesigned, rebuilt, retooled, refactored and conversely, the components which have very little failure rate and high durability which can be leveraged again in future models. Without an invention such as this, drivers would be paying millions of dollars every year to the car dealers and the design engineering team would be left in the cold not knowing a particular or specific engine component can stand up to the seasons and type of driving in the city or highway. Refer to FIG. 7.

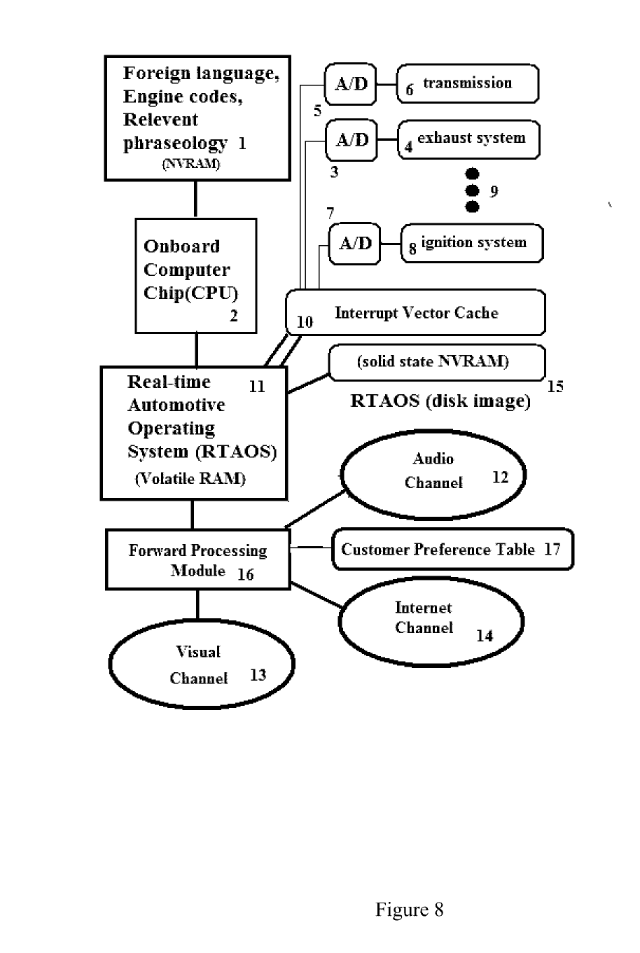

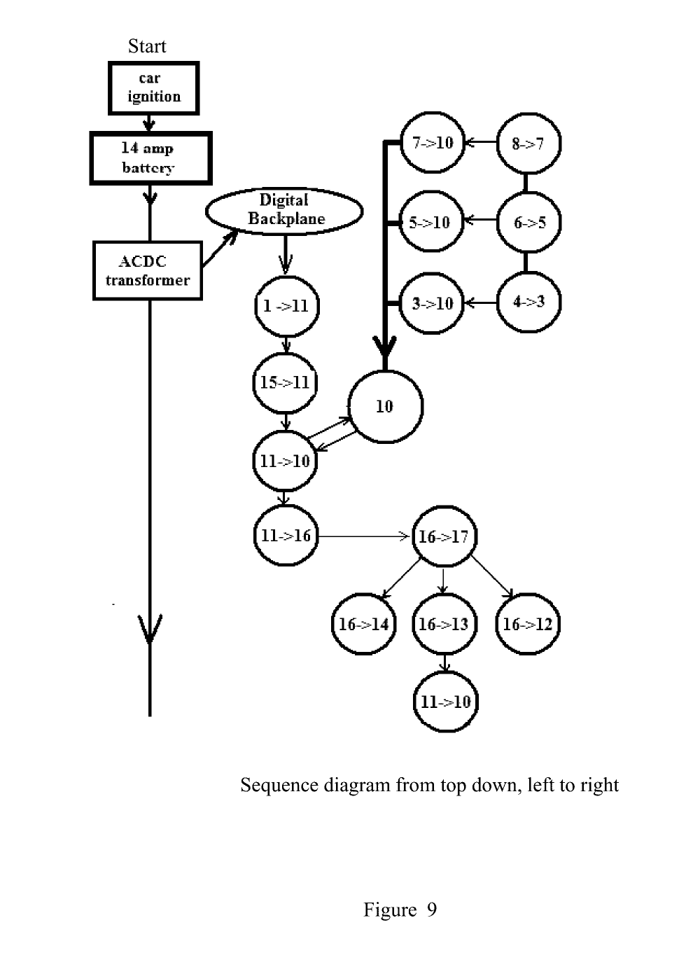

The next schematic is a detailed component diagram of how the engine warning system will work. The pairings of (5, 6), (3, 4), . . . , (7, 8) represent the following: the first number of pair denotes the analog/digital converter and the second pair denotes the engine component being monitored. The interrupt vector cache (10) is the recipient of any and all interrupts raised. Should an engine component fail, the analog portion will send a signal to the digital portion of the converter and the digital signal code. As more engine components fail, the interrupt vector cache acts as a buffer so that the RTAOS can process the interrupt. If there are multiple engine codes generated, the interrupt cache will be able to stow all of them without loss. During the initialization of the RTAOS, the bootstrap OS will come from the NVRAM (15) get loaded into the volatile RAM (11). During normal car operations, should the engine code be dynamically Generated, the first offending engine code interrupt will be stored as the first entry of the interrupt vector cache (10). Subsequently, the RTAOS will lookup the database key engine code found in NVRAM (1), retrieve the warning message(s) for the specific horizontal database row. The entries in the interrupt vector cache may not be cleared, should there be multiple engine warning codes be generated. The interrupt buffers code needs to have sufficient memory storage to support a hundred or so engine codes and messages. The RTAOS will then forward these messages to the forward processing module (16). The forward processing module will then look at the parameters in the customer preference table (17). Depending on what the forward processing module finds in the customer preference table (17), the engine diagnostic codes are then forwarded to either the audio channel (12), visual channel (13) and/or the Internet channel (14). Refer to FIG. 8. The next schematic is a sequence diagram of the power and logic sequence. The car battery is the power source of everything electrical. Through a transformer the alternating current is converted to direct current and thereby creating the power source for the digital backplane consisting of the RAM, NVRAM, CPU. Electrically, this digital backplane must be grounded and the surge protectors must safeguard and prevent spikes in the current which will destroy and irreparably damage the microelectronic constituencies. Refer to FIG. 9.

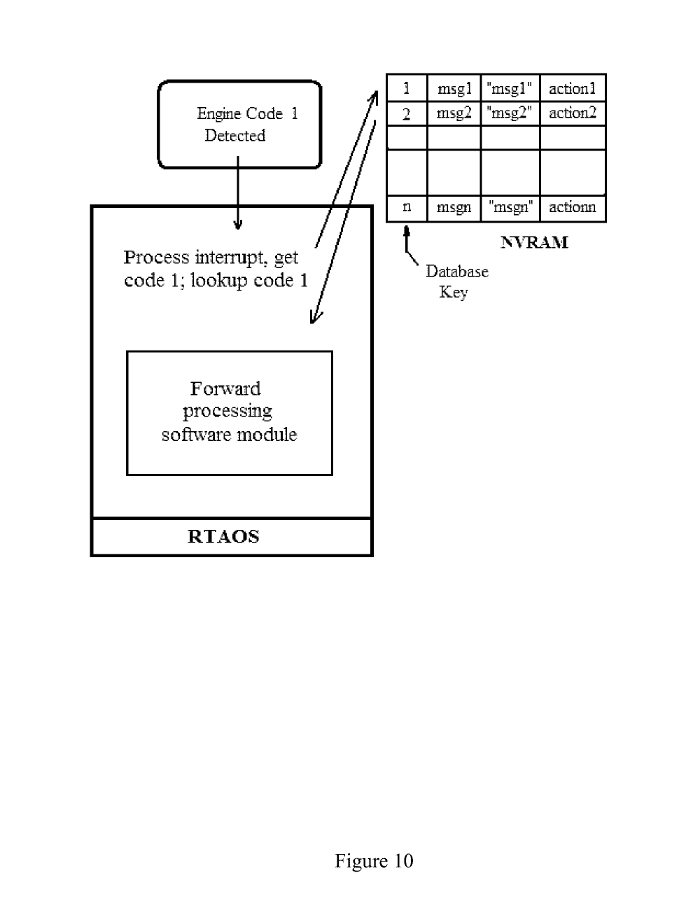

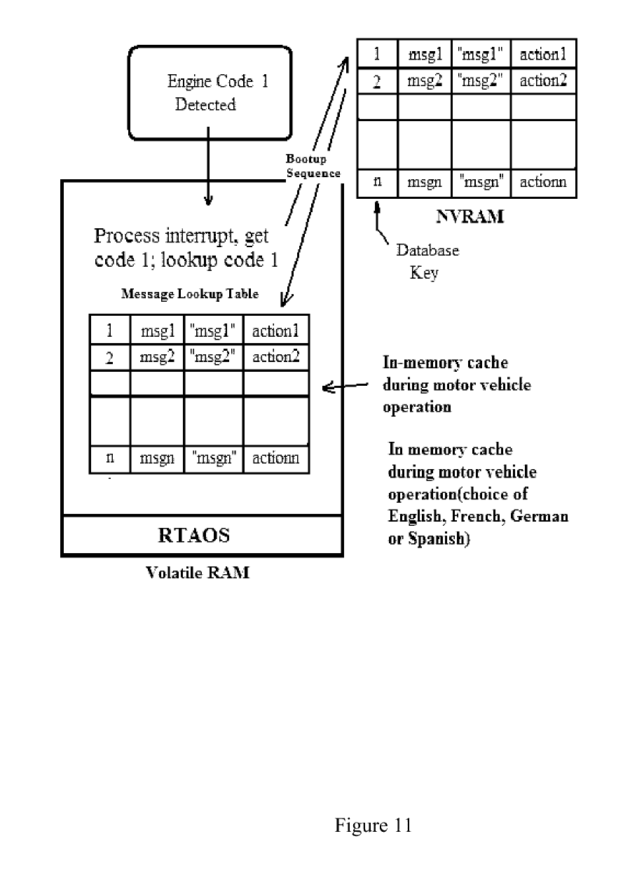

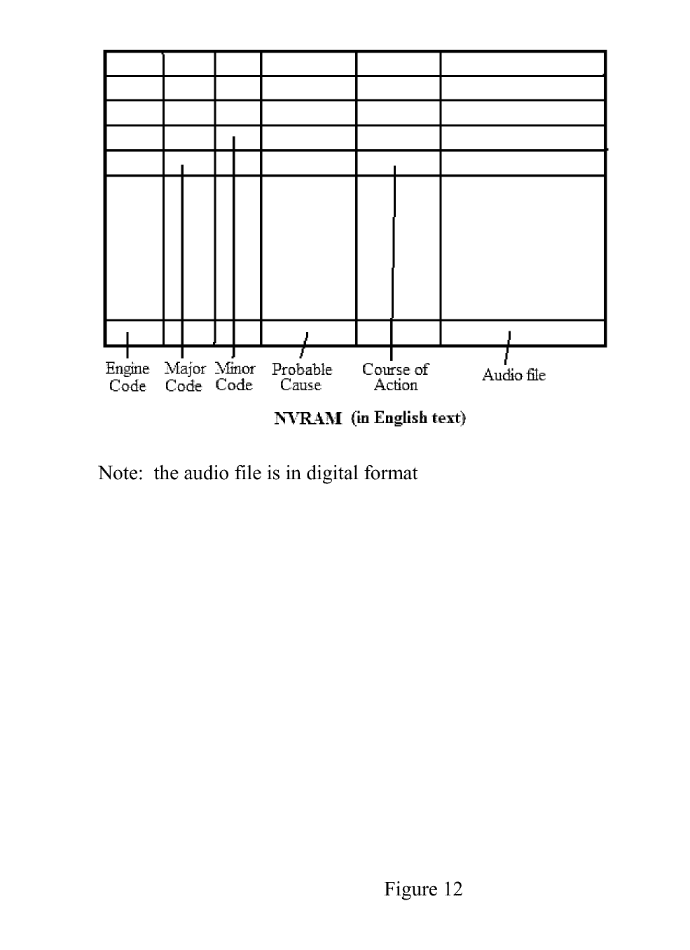

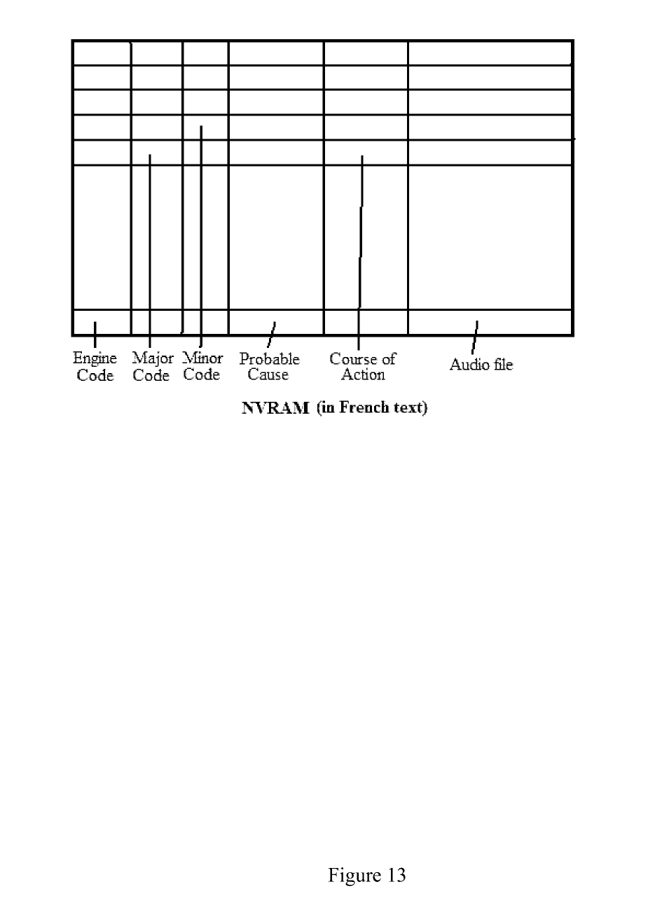

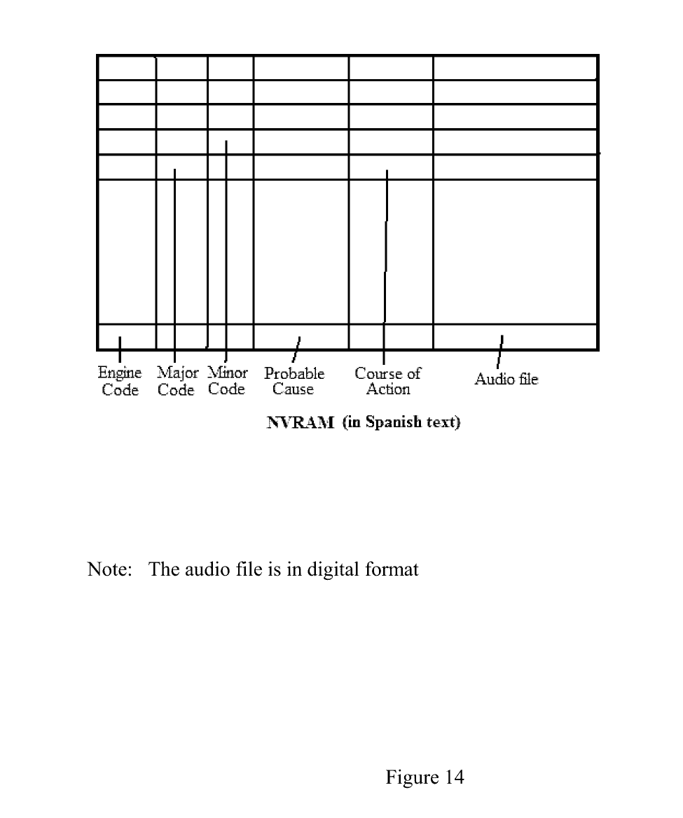

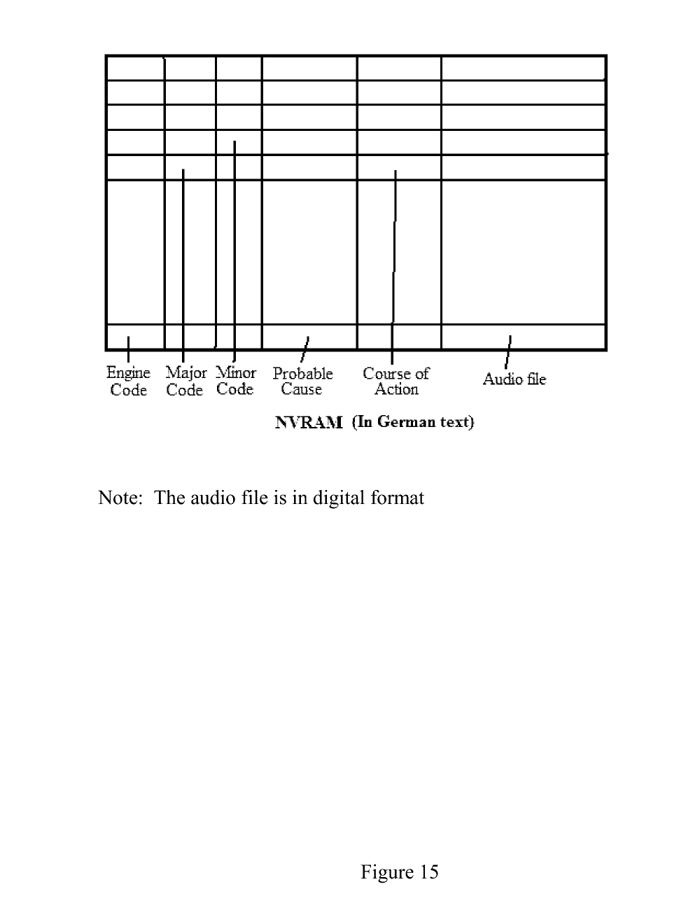

The main processing flow is that once an engine warning code is detected, the RTAOS will use the engine warning code as a database key and lookup the exact nature of the engine component problem. This table is stored on NVRAM. Refer to FIG. 10. To provide a slightly better performance of this database lookup, an optional way is to bring the RTAOS into volatile RAM and then load the NVRAM into volatile RAM. The purpose of this extra step is provide quicker access times to the database. This is the equivalent of an in-memory database. This database can be in English, German, French or Spanish. When the car ignition is started, the NVRAM memory is transferred into the volatile RAM. The message lookup table is, in essence, a mirror image of the NVRAM component. NVRAM's contents is preserved even if the car ignition is turned off. Refer to FIG. 11. More notably, employing the digital component of the NVRAM chip enables the persistence layer, thus preserving the characteristics of the foreign language and the specific car engine codes during the active motoring of the vehicle. The NVRAM main features is that it has in the right most column are the audio files prerecorded in an appropriate digital format. If an engine code has been activated, the corresponding audio message might be “faulty spark plug ignition in the 5^{th} cylinder, please replace soon”. This warning message can be pipelined through the car stereo speakers and through the Bluetooth headset. Refer to FIG. 12. In the second alternative the NVRAM main feature is that it has in the last column, the audio equivalent of the engine warning message in French. The other columns are in French. The engine warning messages can be pipelined through the car stereo speakers and through the Bluetooth headset. The memory contents in the NVRAM will be transferred into the volatile rain in the format of the message lockup table. Refer to FIG. 13. In the third alternative, the NVRAM main features is that it has in the last column, the audio equivalent of the engine warning message in Spanish. The other columns are in Spanish. The engine warning messages can be pipelined and propagated through the car stereo speakers and into the driver's Bluetooth earpiece. Refer to FIG. 14. For German, the same discussion as with the previous figures of 12, 13, 14 respectively. Refer to FIG. 15.

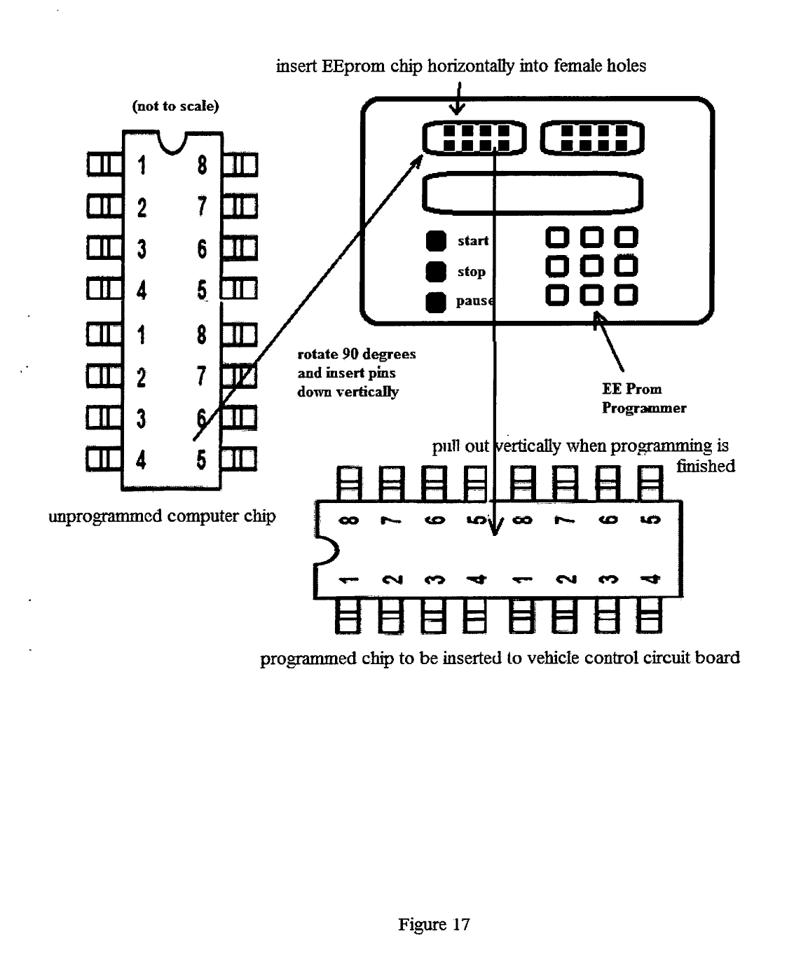

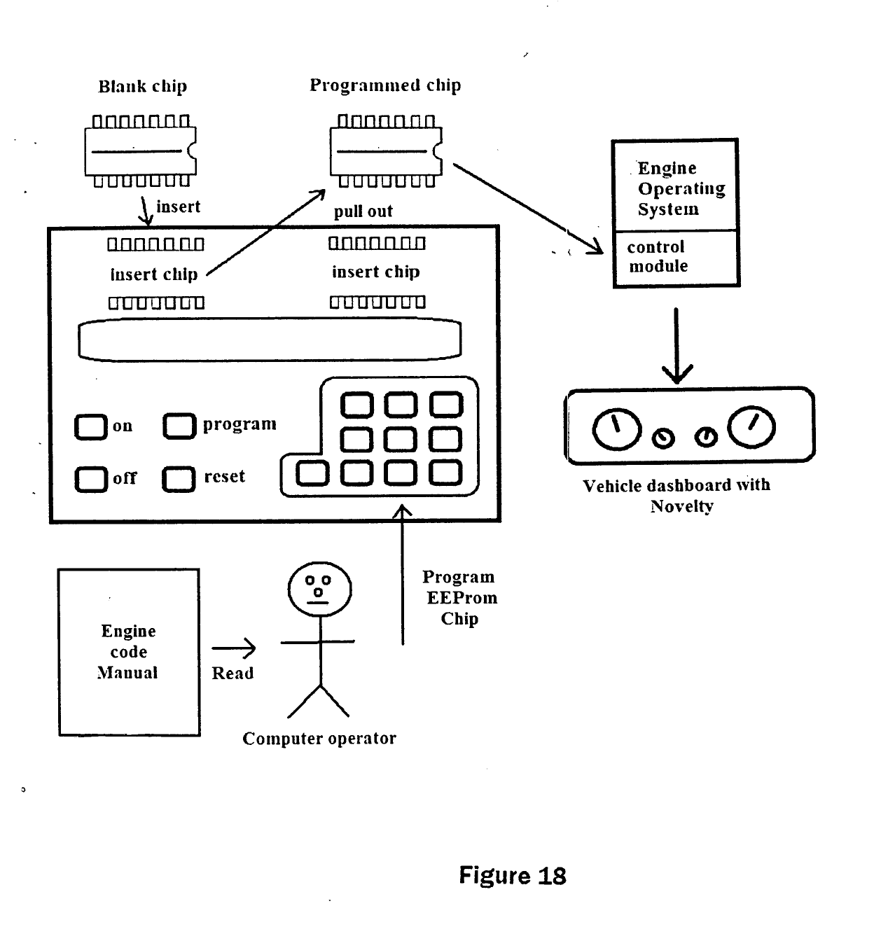

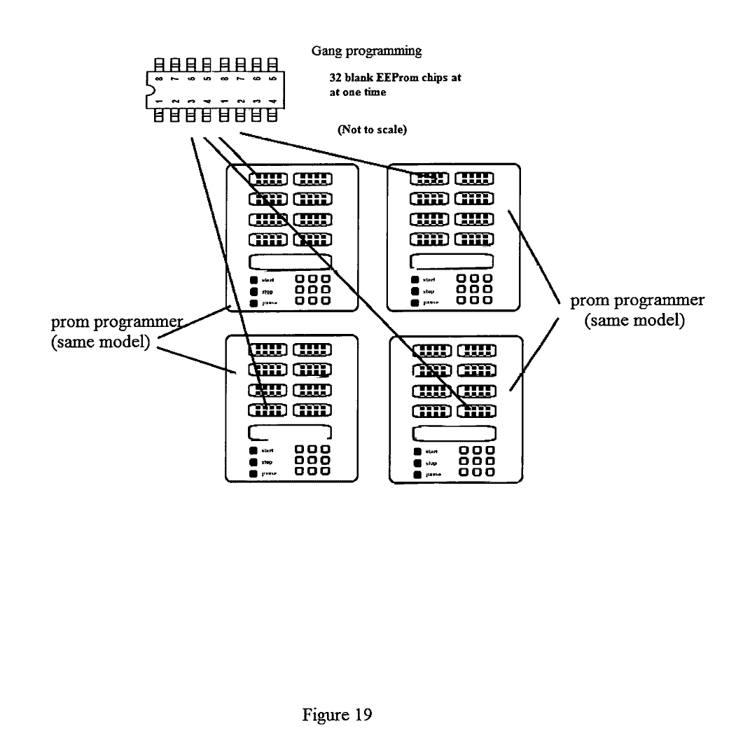

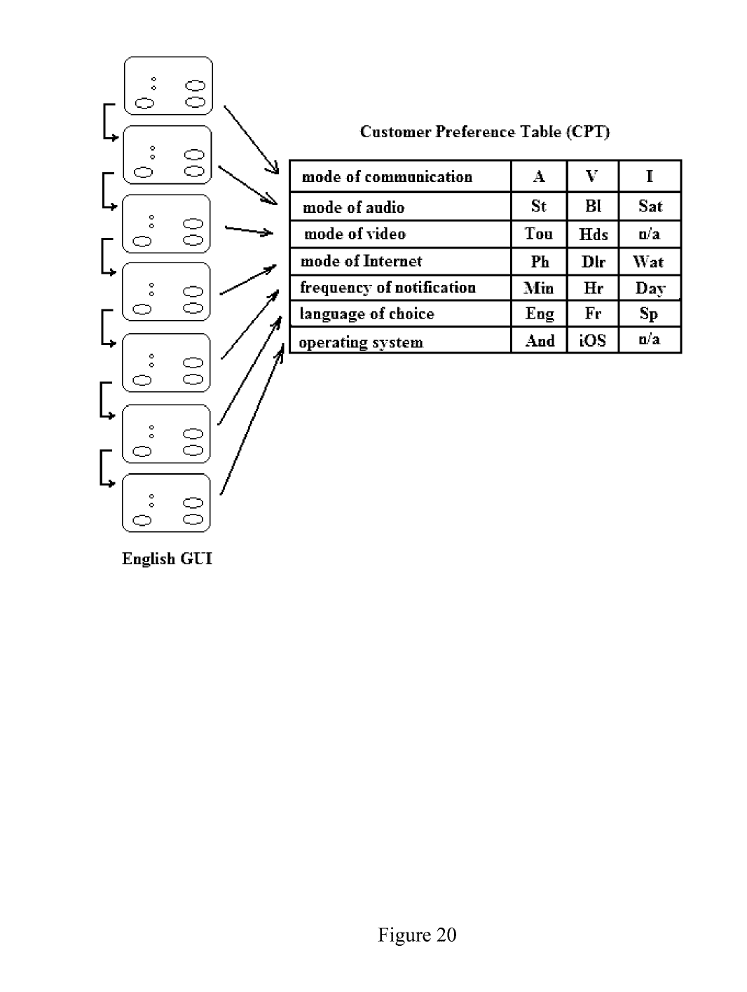

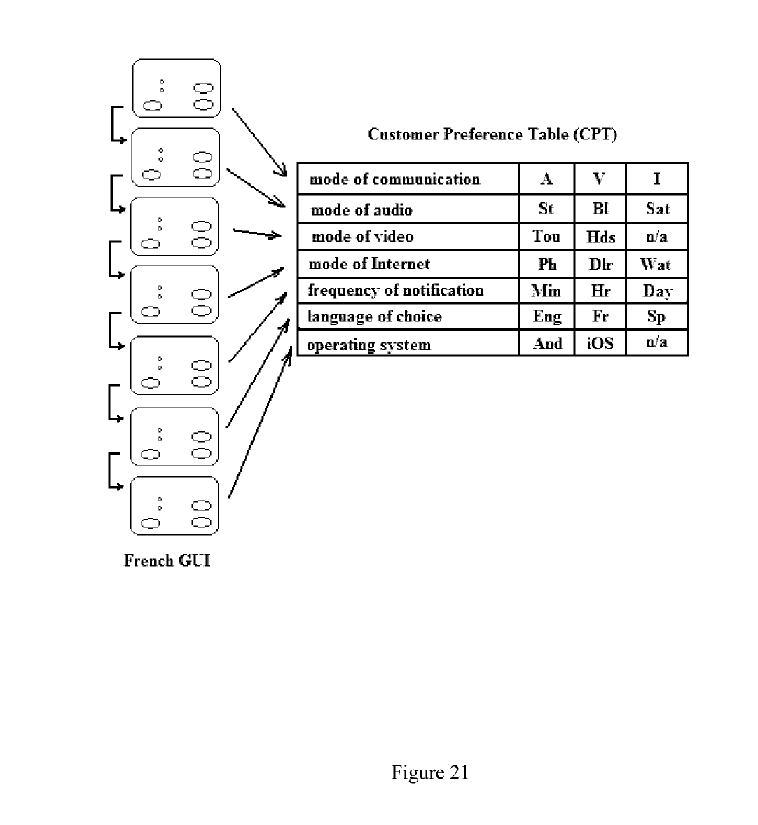

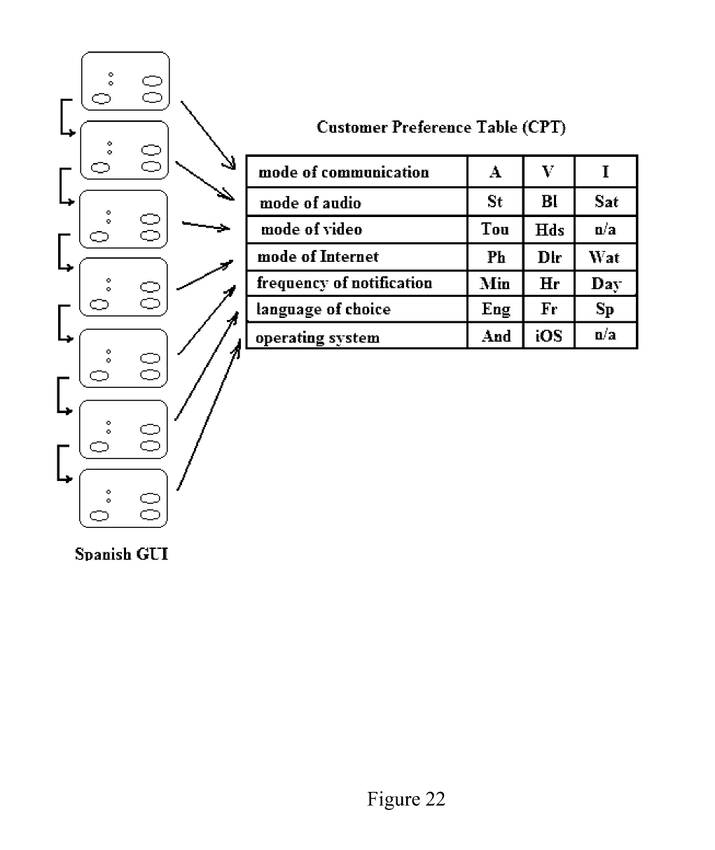

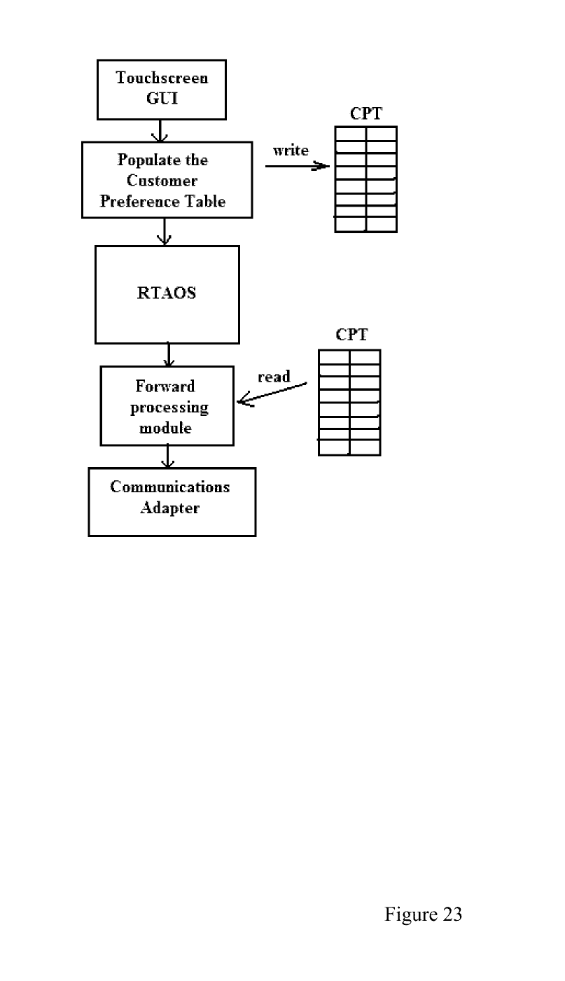

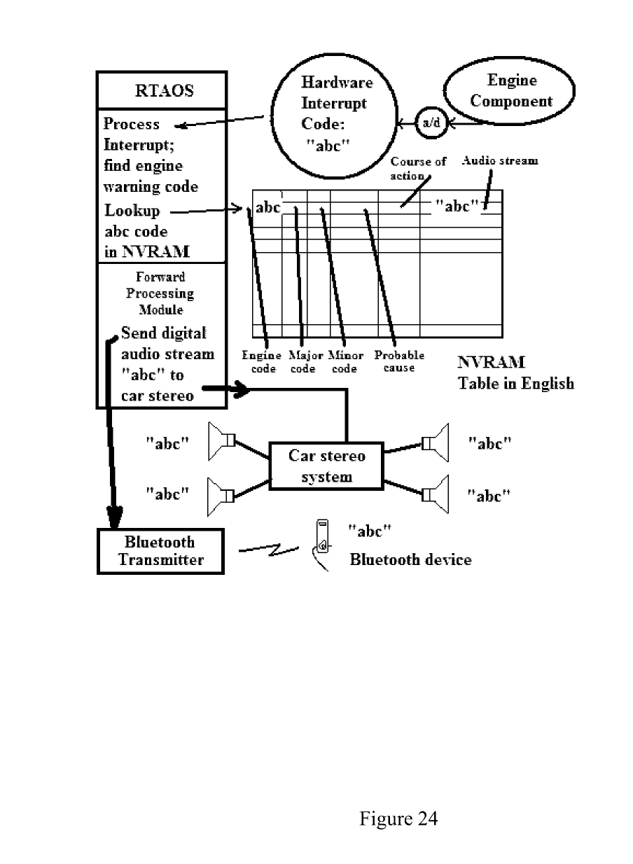

So far in this portion of the description of detailed of the novel invention, there has been frequent references to the NVRAM. The tool of choice to program the NVRAM is the prom blower or prom programmer. NVRAM stands for non-volatile random access memory. The next figure exemplifies how the engine codes for car model XYZ get encapsulated. A blank NVRAM get placed into slot 2 and a series of logical sequences gets programmed on the prom blower and systematically, the memory of the NVRAM chip gets populated with the engine warning messages. Once the engine warning messages and codes occupies the available memory capacity of the NVRAM, then it is ready to be used in conjunction of the RTAOS. Refer to FIG. 17. Each vehicle XYZ will have at most one programmed NVRAM chip. The next point made is that the engine codes/warning messages for a different car model ABC will have a different NVRAM memory sequence. Refer to FIG. 18. Thus, for different car models require different engine code sequences and consequently, different NVRAM codings. Because encoding an NVRAM is a time consuming endeavor, gang programming twenty to fifty chips at a time is far more practical and scalable for a car factory floor. Refer to FIG. 19. The forward processing module is to heuristicly route the engine warning messages to the appropriate communications adapter among other things. During the customer initialization sequence there are 7 parameters which need to filled out by the customer. The results of the customer responses are captured and tabulated in the customer preference table (CPT). The customer can change any or all of these engine warning options by revisiting and navigating through the various GUI panels and selecting the appropriate option(s). Note that the GUI panels themselves are in English. Refer to FIG. 20. Should the driver prefer French, then the 7 GUI panels would be displayed in French. The underlying customer preference table (CPT) is foreign language agnostic. The forward processing module does not care what language the driver chooses, since the constituencies of RTAOS are digital. Refer to FIG. 21. Should the driver prefer or opt for Spanish, then the 7 GUI panels would be displayed in Spanish. The underlying customer preference table is language agnostic. The forward processing module does not care what language the driver chooses, since the constituencies of RTAOS are digital. Refer to FIG. 22. Thus the life cycle of the customer preference table is during the customer initialization phase the entries of this table are written, during the normal operation of the car vehicle, the entries are read by the forward processing module. Refer to FIG. 23. One of the outstanding features of this novelty is to have the wherewithal to communicate the engine warning diagnostics over the car stereo system. This is akin to a friendly tap on the shoulder to the car vehicle owner informing in the native language of his/her choice what the problem is. The next schematic exemplifies the life cycle of failing engine component being processed by RTAOS, doing the database table lookup and retrieving from NVRAM, the specific audio digital stream signifying the engine warning/problem. The forward processing module then interrogates the customer preference table and marshals the digital audio stream to the Bluetooth headset and/or the car stereo speaker system. Refer to FIG. 24.

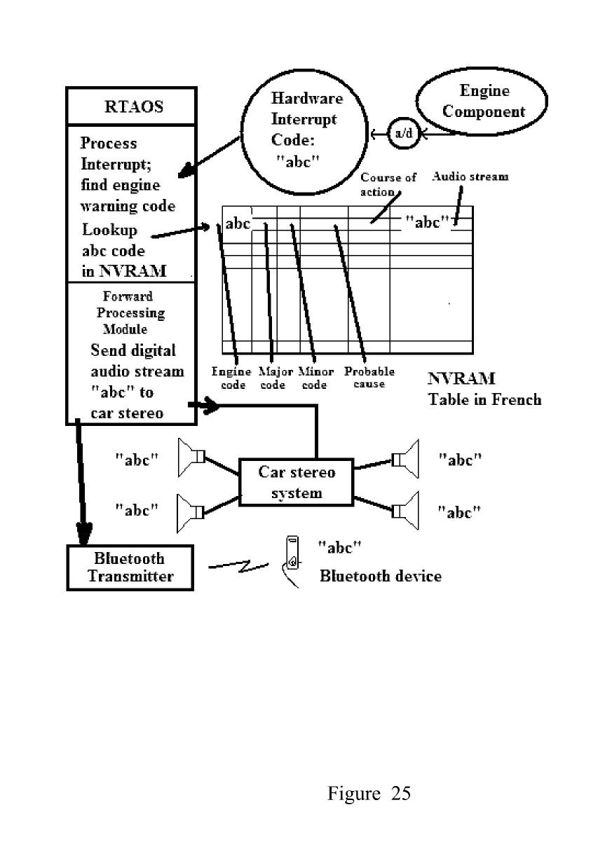

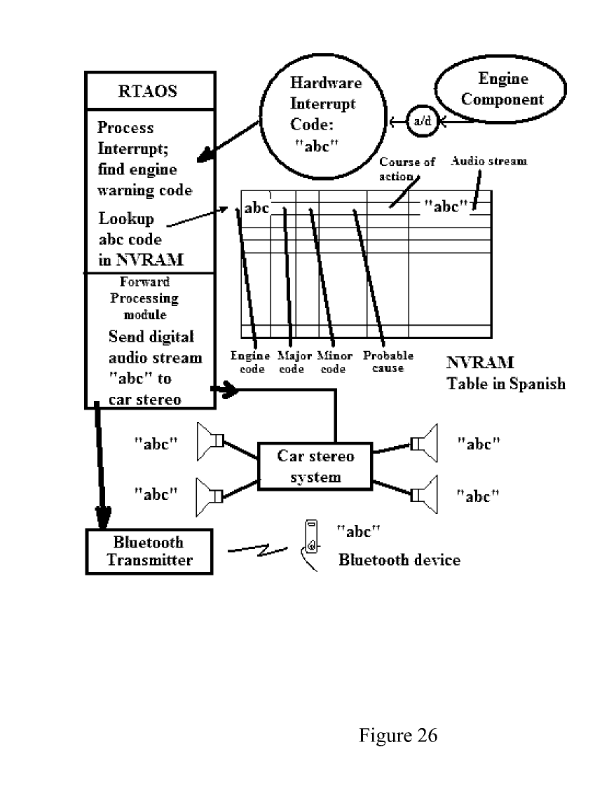

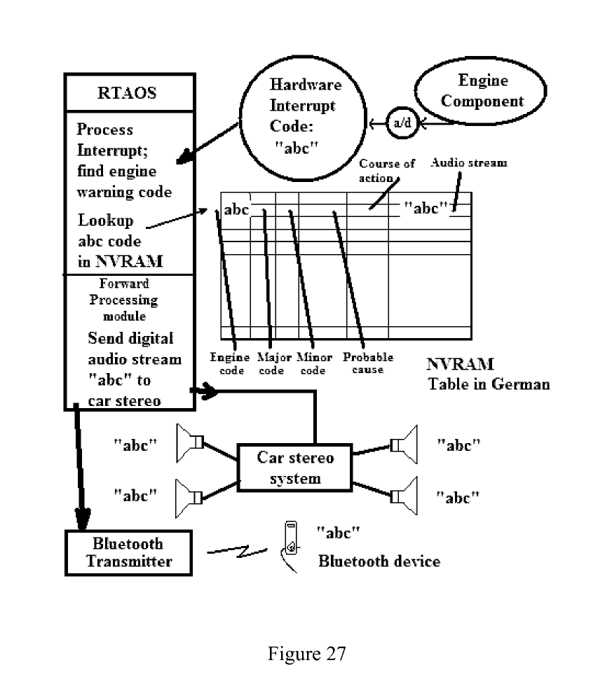

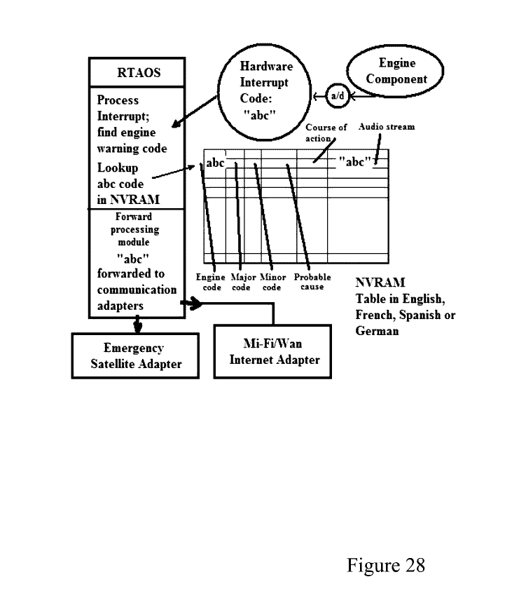

The next schematic exemplifies the life cycle of failing engine component being processed by RTAOS, doing the database table lookup and retrieving from NVRAM, the specific audio digital stream in French signifying the engine warning/problem. The forward processing module then interrogates the customer preference table and marshals the digital audio stream to the Bluetooth headset and/or the car stereo speaker system. Refer to FIG. 25. The next schematic exemplifies the life cycle of the failing engine component being processed by RTAOS, doing the database table lookup and retrieving from NVRM, the specific audio digital stream in Spanish signifying the engine warning/problem. The forward processing module then interrogates the customer preference table and marshals the digital audio stream to the Bluetooth headset and/or the car stereo speaker system. Refer to FIG. 26. FIGS. 24, 25 and 26 share a common RTAOS and electrical infrastructure. Only the NVRAM table reflects the native language of the driver whether it is French, Spanish or English. The separation of concerns between the automotive operating and the NRVAM makes the overall systems architecture extensible. In a similar connect, via the fully populated customer preference table, the resultant engine warning messages can be set to the emergency satellite channel and/or the MiFi/WAN communications adapter. Having broadband Internet access is so commonplace, the novelty fully takes advantage of this wide area network communications facility. Part of the outbound email message will contain the car VIN number, driver's name, registration and license. For brevity's sake, the next schematic will not made in triplicate. The NVRAM can be English, French and Spanish. Refer to FIG. 26. Or in German as in FIG. 27. The full fruition and practical realization of using the Mi-Fi communications adapter allows for propagation of the engine warning messages to the automobile owner's digital devices—the smartphone, the tablet, smart watch, laptop and infotainment center. With the proliferation of digital devices, this entire ecosystem becomes the Internet of Things. Also, most essentially, the engine diagnostic messages can be forwarded to the repair facility of the car dealer. This can save 30 minutes of the car technician working on the car and gives the technician some time to make the requisition of the parts needed to successfully rectify the engine component problem or anomaly. Some cars have a 24 by 7 emergency communications channel, the engine warning messages can be forwarded to a satellite call to the emergency call center. The engine warning messages can be forwarded via a telephone call to the repair facility/auto dealer. Refer to FIG. 28.

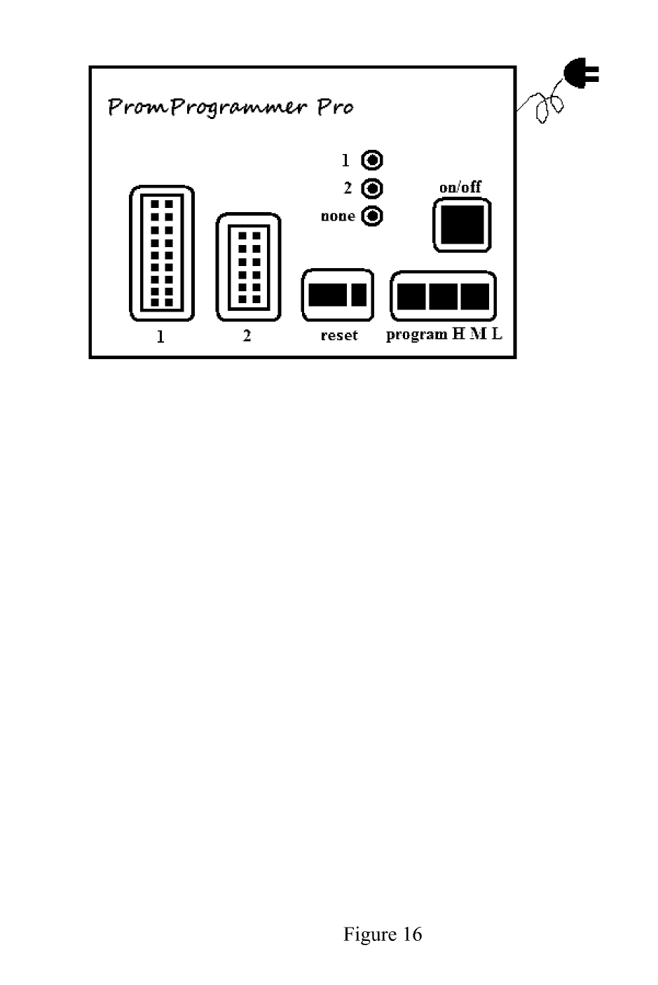

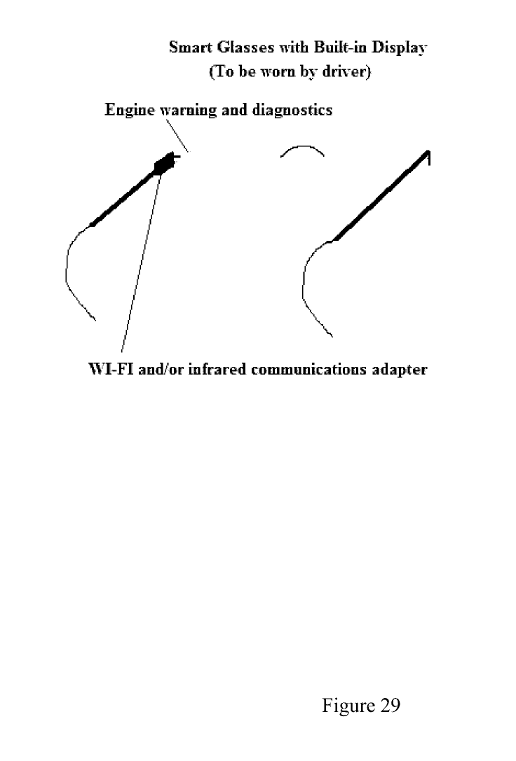

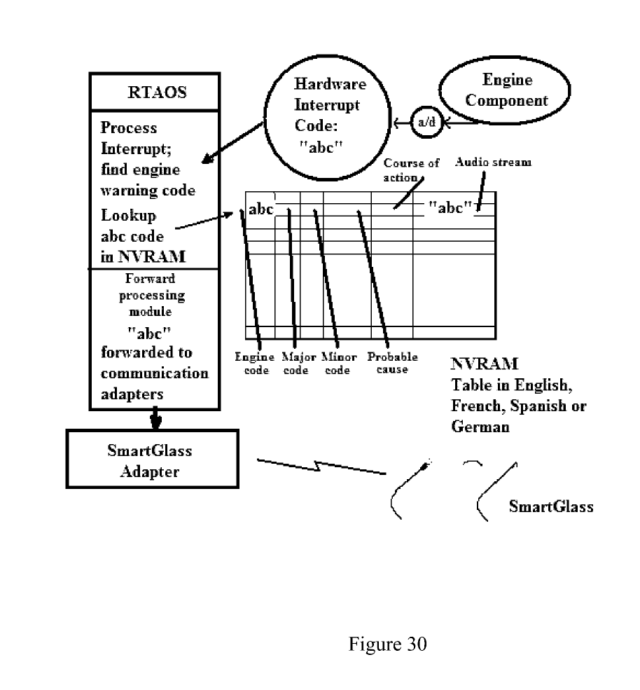

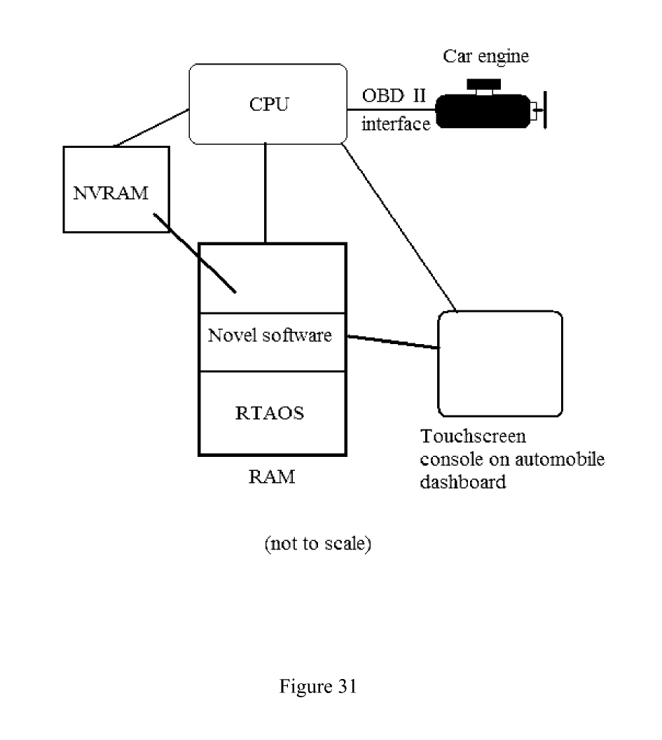

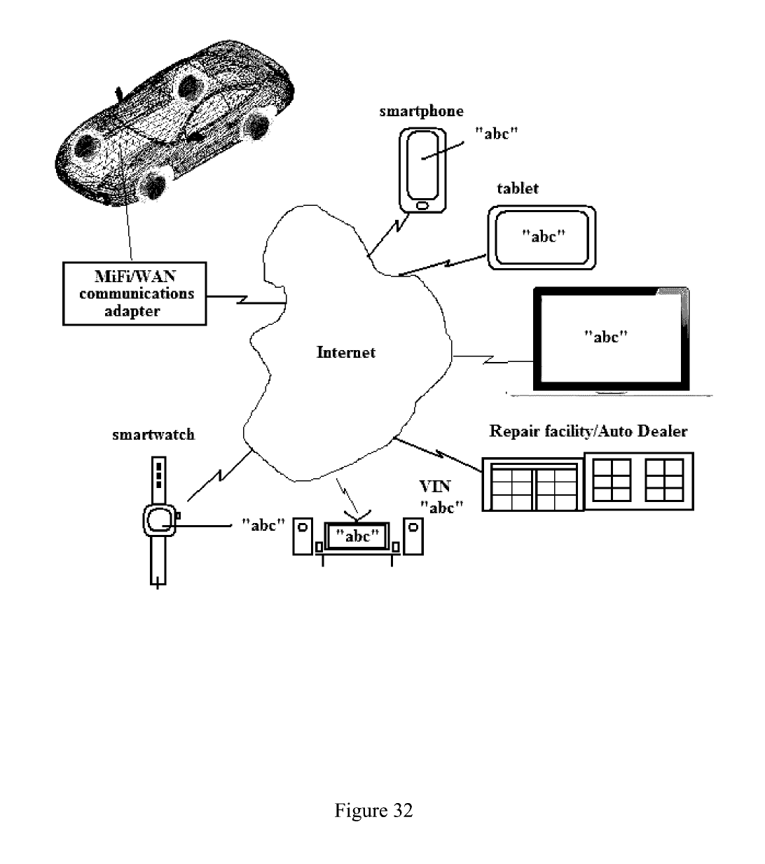

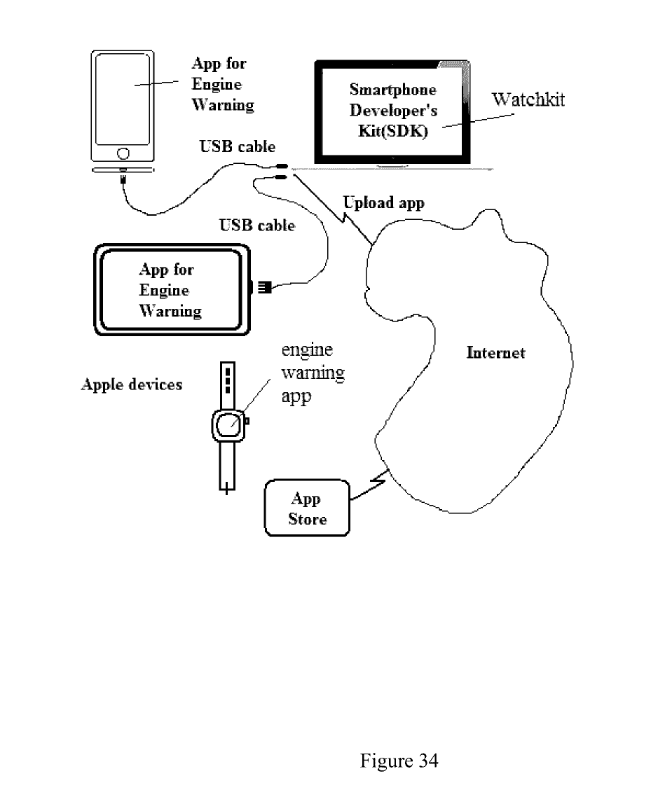

For the visually unimpaired, the engine codes and diagnostics can be uploaded wirelessly to a pair of smart vision goggles. Refer to FIG. 29. The communications is via a wireless channel such as WIFI or Bluetooth from the RTAOS to the smart glass wearer. Refer to FIG. 30. This discussion so far from FIGS. 5 through FIG. 30 is predicated upon a key hardware and software infrastructure foundation. The automobile must have a CPU chip to control and monitor the car engine's health and performance metrics. The automobile must have an existing vehicle operating system (RTAOS). To logically encapsulate the vehicle's unqiue engine error, warning and diagnostic codes, an NVRAM must be incorporation onto the vehicle's onboard computer board. The software embodiment of the novel invention must be written, coded and validated along with the existing software of the RTAOS. The RTOAS and the software embodiment of the novel invention will logically reside inside the RAM (random access memory. Finally whatever engine warning diagnostics and error codes must be displayed upon the touchscreen console which is usually juxtapositioned between the driver and front passenger. The heavier black lines depict the new I/O control interfaces required for this novelty. Refer to FIG. 31. The logical extension is to have the IOT where the set of engine codes and diagnostics can be disseminated or propagated across the various Internet communication channels. Refer to FIG. 32. The more sophisticated cars can have a communications satellite uplink. The typical service for this type of service is for 24 hour emergency roadside repair and tow. The messages can be passed along to the local car dealership to the repair department. To get the car driver's handheld devices—smartphone, tablet or smart watch, a developer will need a modest app to be built usually on a laptop with the SDK. The SDK has an emulator or virtual device available to simulate these handheld devices to validate the logic. Once the developer is sufficiently satisfied with the logic and GUI of the app, he/she can then upload the finished app to the app store. This development methodology is for Apple devices.^{3 4} Refer to FIG. 34. ³ Ipad Programming, Steinberg and Freeman⁴ iOs6 Programming Napier and Kuman

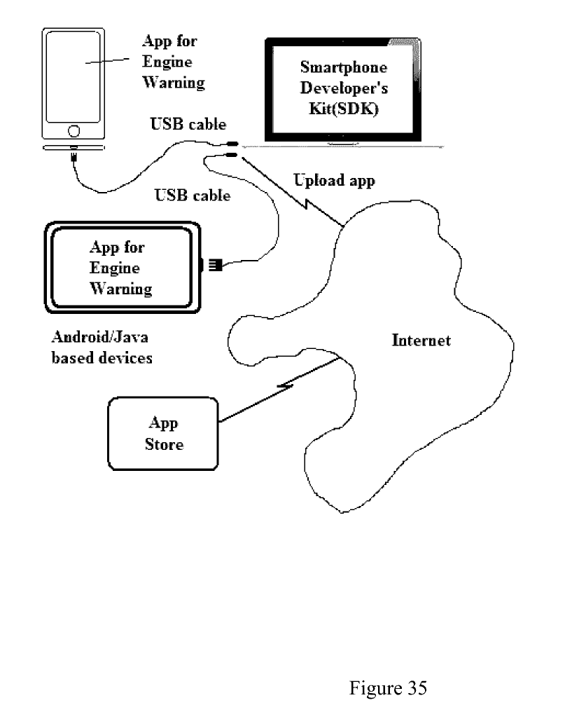

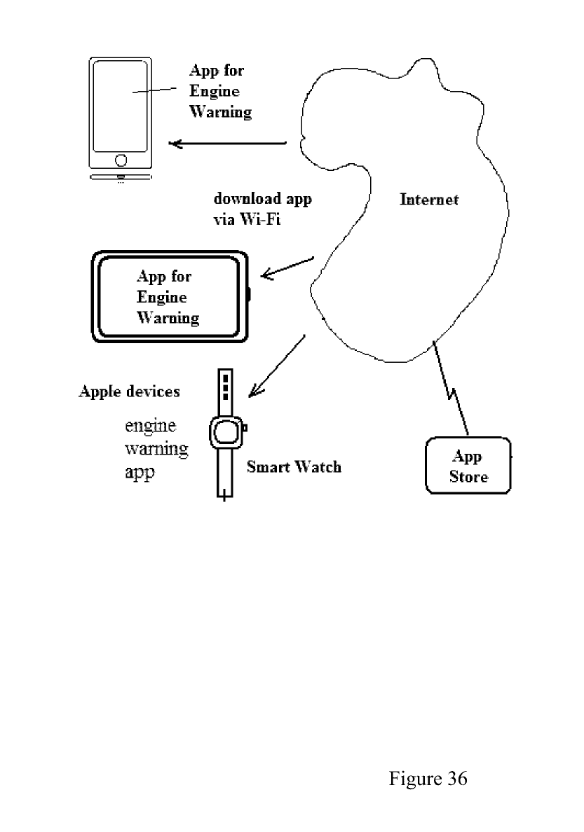

To get the car driver's Android handheld devices—smartphone or tablet, a developer will need a modest app to be built usually on a laptop with the SDK. The SDK has an emulator or virtual device available to simulate these handheld devices to validate the application, GUI and communications logic. Once the developer is sufficiently satisfied with the robustness and accuracy of the logic, the mobile application can be uploaded the finished app to the app store. This development methodology is for Android devices. ^{5 6} Refer to FIG. 35. For the car owner with the Apple handheld device, the Apple owner can go to the app store and download the app onto the handheld device via Wi-Fi. Refer to FIG. 36. ⁵ Android Programming Unleashed, Harwani⁶ Beginning Android Tablet Programming, Matthews

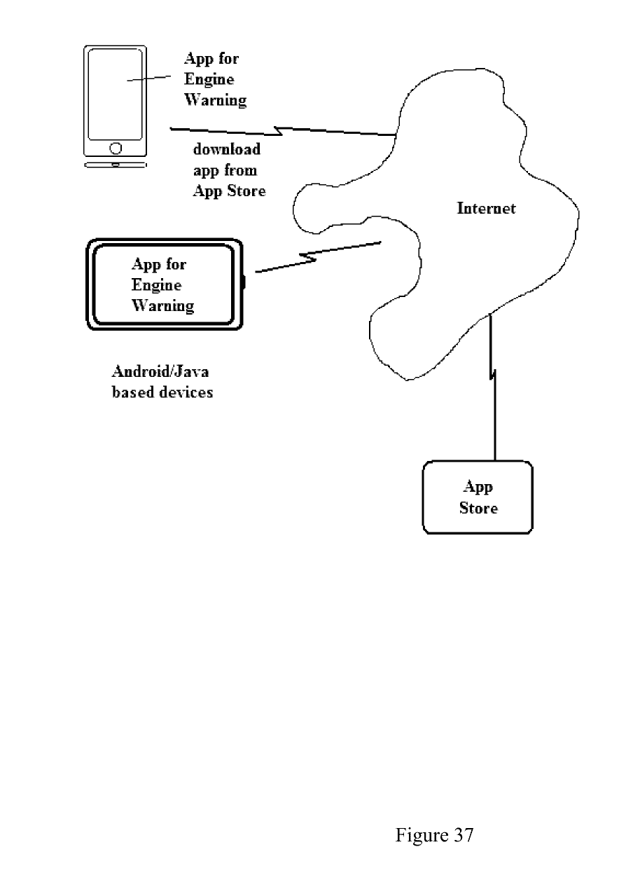

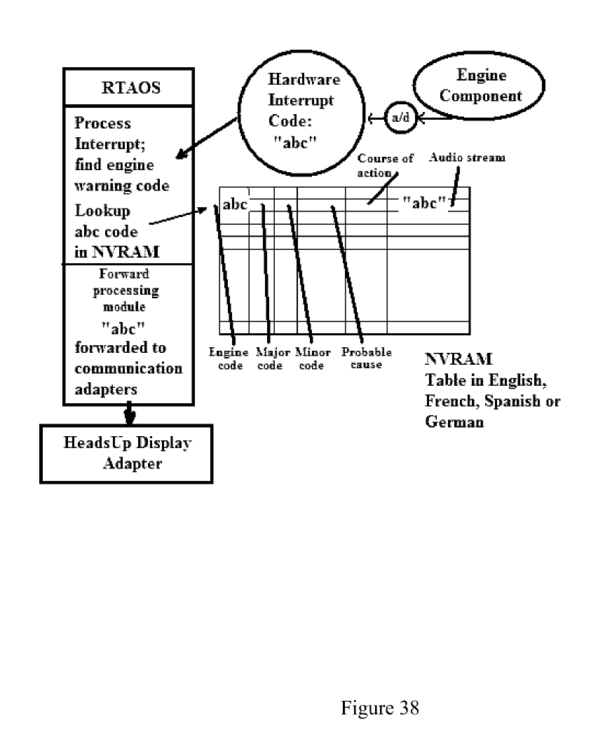

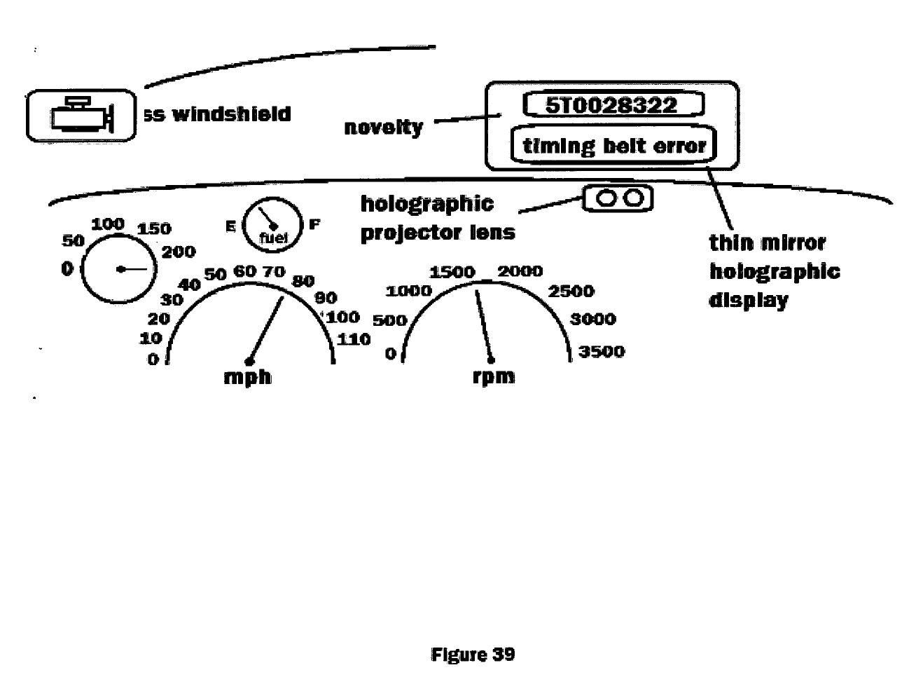

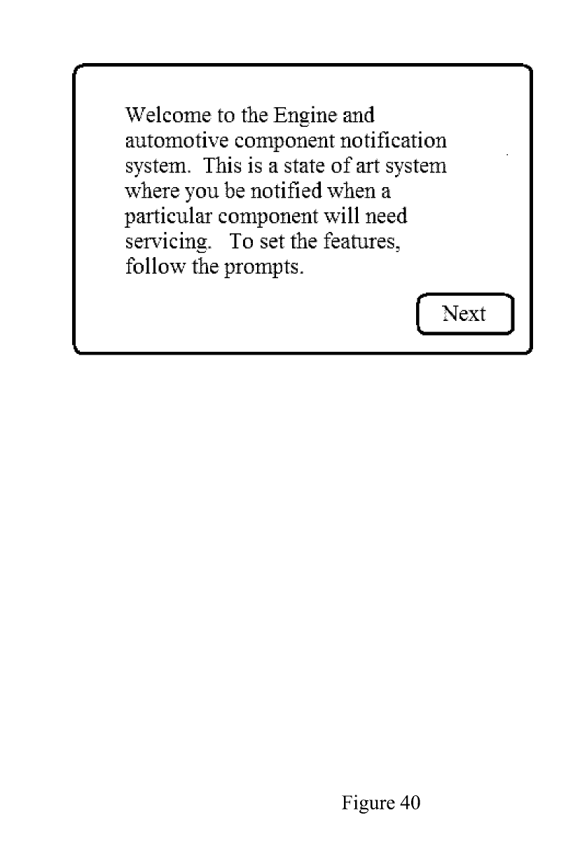

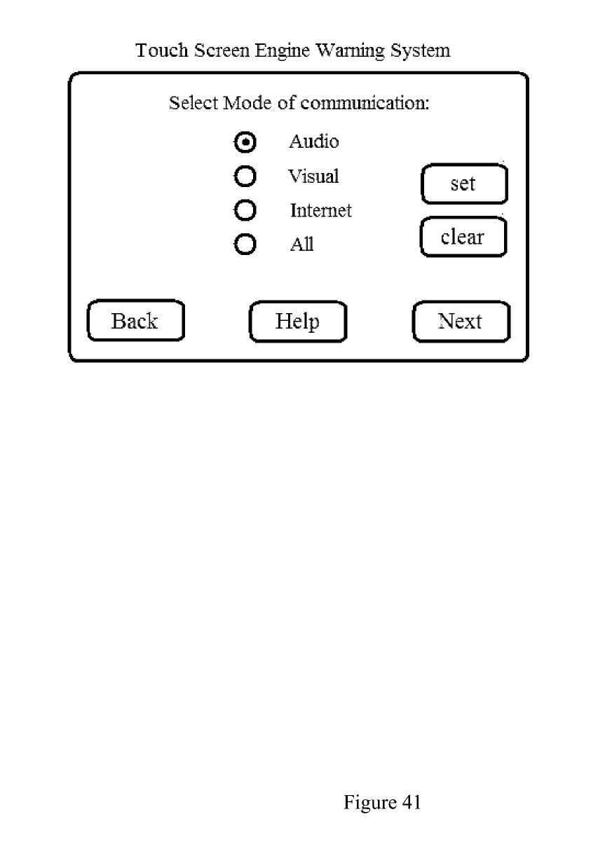

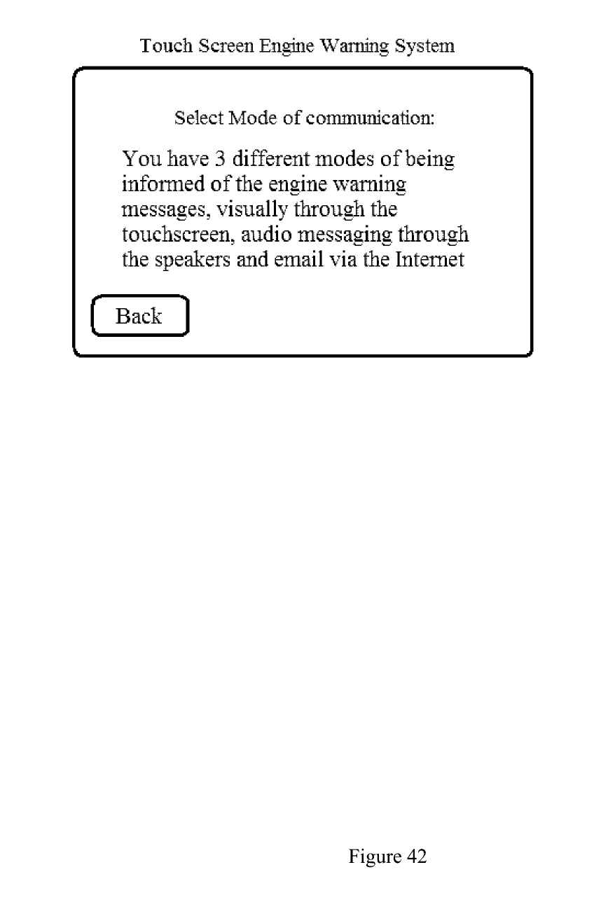

For the car owner with an Android hand held device, the app can be downloaded from Android app store. As with the Apple owner, Wi-Fi can be used to get app wirelessly from the app store. Refer to FIG. 37. One of the ways to display the engine diagnostic information is through the heads up adapter. The logic flow from the engine component follows pretty much how the engine warning messages can be conveyed to the automobile driver. Note the engine warning messages can be displayed in English, French or Spanish. Refer to FIG. 38. The resultant output is a virtual display which mimics a display on the touchscreen console. Refer to FIG. 39. Because there are quite a few choices and options for the output delivery of the engine warning messages, there is a software based configuration guide to be implemented. Once the car ignition starts and brings the RTAOS into operation, a nominal welcome screen elicits the car driver for the necessary input. This first screen is an obligatory welcome screen in which after reading the short verbage, instructs the driver to touch the button entitled “Next”. Refer to FIG. 40. The next screen asks the car driver to select in which ways the engine diagnostic messages should be displayed. The default radio button is set to “Audio”. The driver can select at least one, two or all three ways. Once the car driver makes the selection, the button entitled “Set” is touched. If the driver decides to do something else, then the button entitled “Clear” is touched and the driver will start over with making the choices of communication. Regardless of the choices made by the driver, by touching “Clear”, this will reset this touchscreen panel to “Audio”. Once the choices of mode of communication are made, the driver can proceed to the next screen. This is done by touching the button “Next”. If the driver wants to go to the previous screen, the button entitled “Back” is pressed. The consequence of this action is that any of the options on this screen will be lost. The driver also has a help button to find out more on what the current screen can do. Refer to FIG. 41. The next screen is the companion help screen to the screen which allows the selection of the mode of communication. The help screen facilitates knowledge of what options the driver can pick from. Once the driver comprehends the targeted purpose of the specific GUI panel, he or she can press the “Back” button to return to the current GUI panel. Refer to FIG. 42.

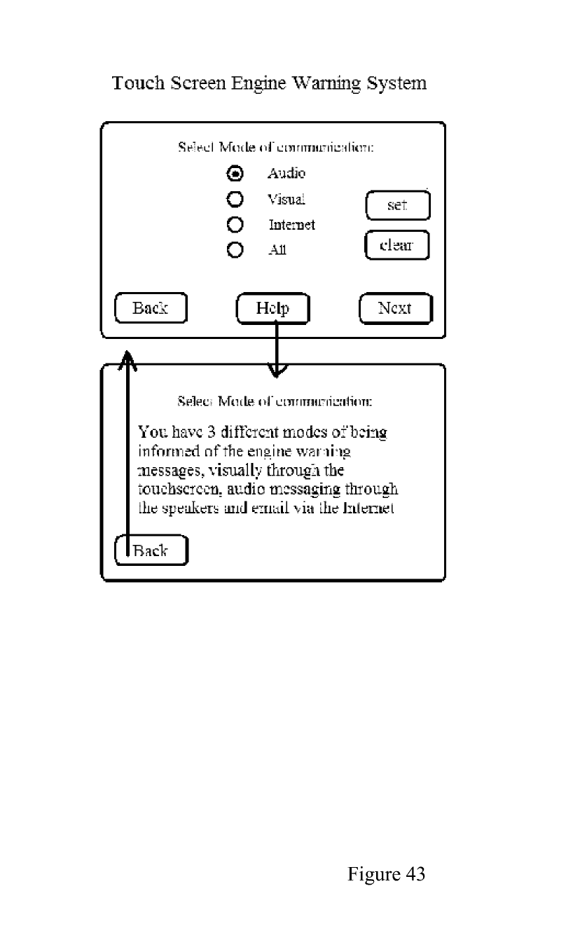

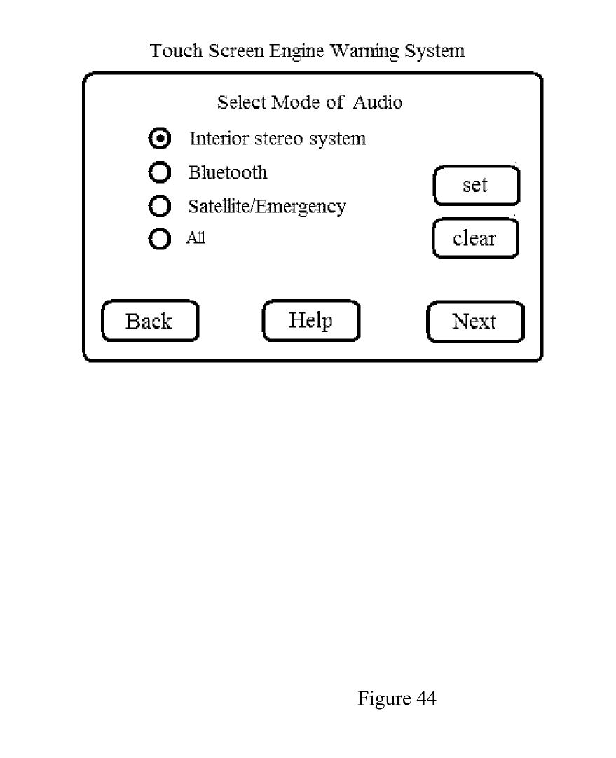

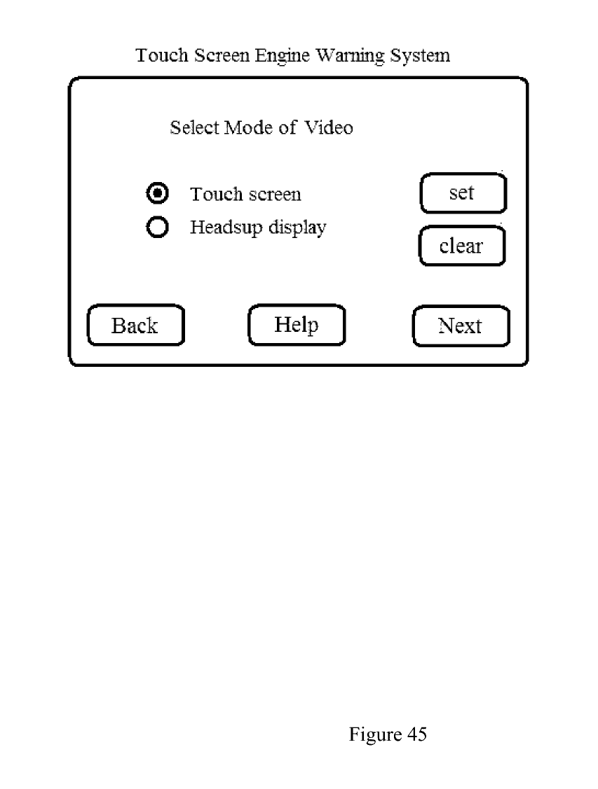

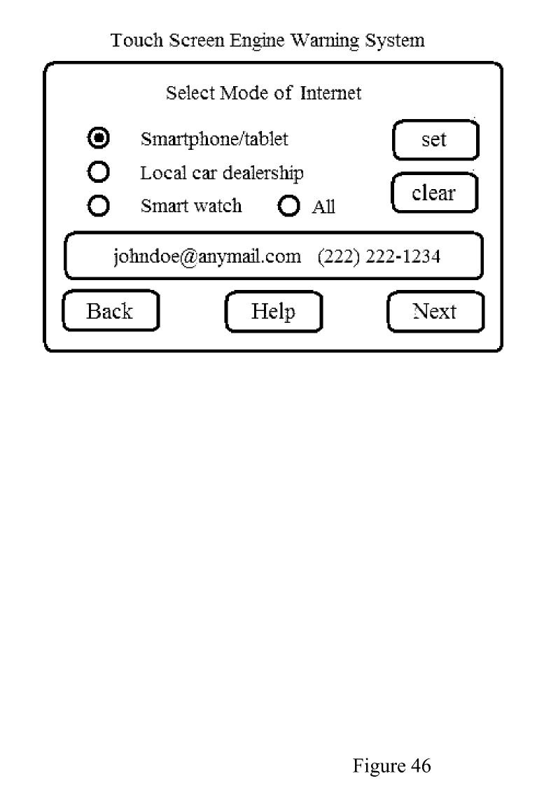

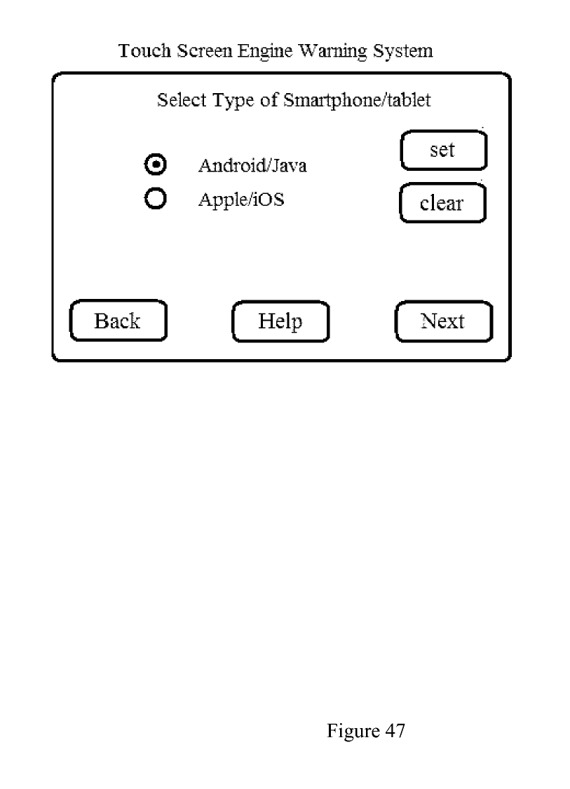

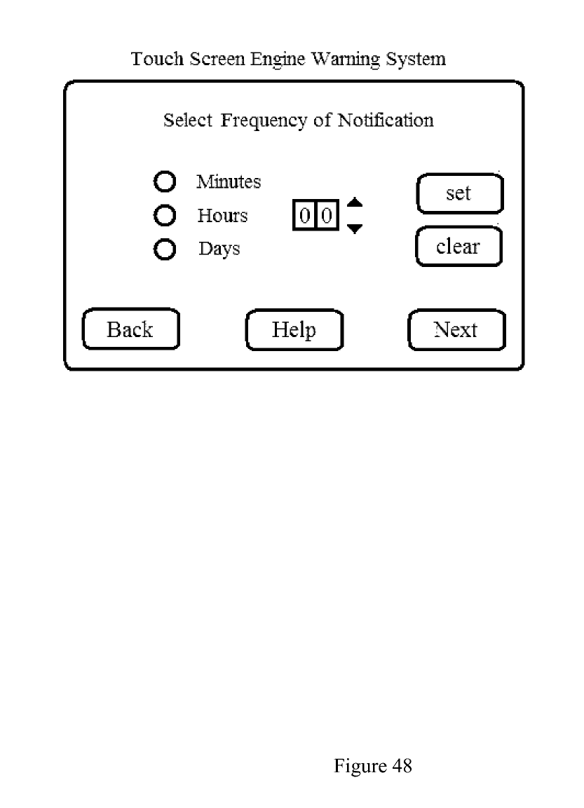

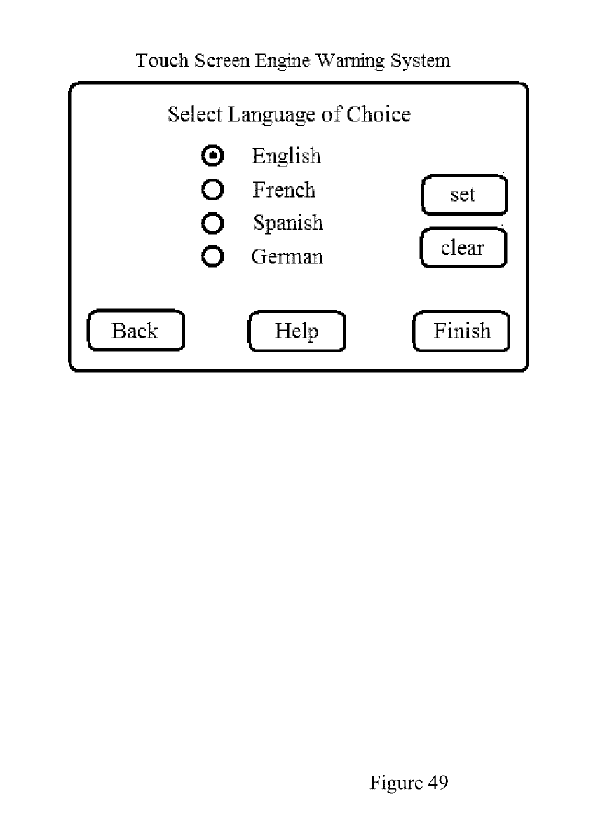

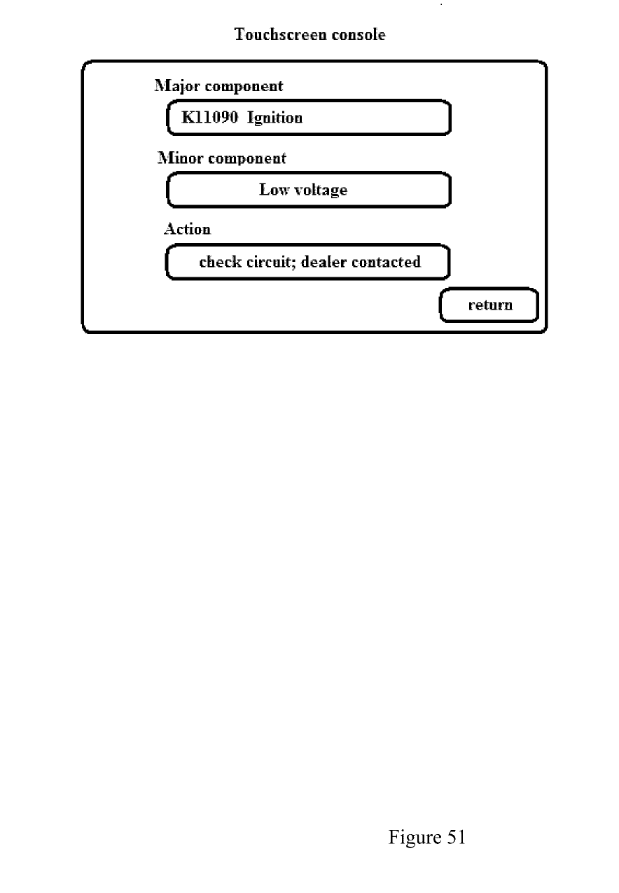

The next figure show the logical relationship of the GUI panel and the companion help screen. The direction of arrows show what GUI panel will show on the touchscreen panel. Refer to FIG. 43. The next screen enables the driver to select the mode of audio. There are three options where the driver can pick one, two or three. The default selection is the interior stereo system. Should the drive touch the “Clear” button, the software will revert back to the default selection. As with the previous screen, the menu navigation actions on the buttons entitled “Back”, “set”, “clear” and “next” are the same. There is a “help” button which enables the driver to find out additional information on this specific GUI panel. Refer to FIG. 44. The next screen allows the driver to select one, two or zero options. These options allow for the select of video (visual) display of the engine warning messages—touch screen and/or headsup display. The default choice is the touch screen with the radio button selected. If the driver selects or touches the “Clear” button, the software navigation system will revert back to the default choice of “Touch screen”. As with the previous screen the actions on the buttons entitled “Back”, “set”, “clear” and “next” are the same. Morever, there is a “help” button to enable the driver to obtain further information on this GUI panel. Refer to FIG. 45. The default is the top choice, when the driver navigates to this screen. The next screen shows what options the driver can make for the selection of the mode of Internet. The choices are smartphone/tablet, local car dealership and/or smart watch. There is a textbox where the driver can enter his/her email as well as the car dealer's email address. The four buttons of “set”, “clear”, “back” and “next” all behave the same way as with the previous screens described. As with all the previous GUI screens, there is a “help” button. Refer to FIG. 46. The next screen refers to the options available for the driver to select the type of handheld either Apple (iOS) or Java (Android). The default choice the driver will see is the top entry. Should the driver select or touch the “Clear” button, the software navigation system will revert back to the default selection at the entrance of this GUI panel. The four types of buttons have the same behavior as with the previous screens. Refer to FIG. 47. One of the nicer features of this solution is having a timer to control the interval of the when the engine diagnostic warnings will occur. The next screen has a dial and adjustable time granularity of minutes, hours, and/or days. For example if the driver only selects minutes and adjusts the two digit setting to “10”, then should the engine warning message be activated through RTAOS, the message(s) will appear on the touchscreen console and/or speaker system every 10 minutes. The five buttons for navigation “set”, “clear”, “back”, “next” and “help” functionality remains consistent as before. Refer to FIG. 48. Through the solution of the problem, there has been a prevailing theme of multi-lingual support. The essential purpose is to provide the drivers of different nationalities to enjoy the automobile's specialized customization. So to implement this feature, the next screen allows the user to select the language of his/her choice—either English, French, German or Spanish. There can be only one choice. Because this screen is the last of this GUI sequence, the buttons “set”, “clear”, “help” and “Back” have the same navigational consequences as with the previous screens. The one major difference and unique feature of this screen is that there is a “Finish” button. Should the driver push this button, then all the changes from the various screens will be saved into the customer preference table. When the RTAOS is in operation, the customer selections will be used to route the engine warning messages to the appropriate communications adapter. Refer to FIG. 49. If we coalesce the last eight screens into a composite flow diagram, then FIG. 49 epitomizes the logic flow. The left column from top to bottom Is the navigational sequence which the driver will follow. This is accentuated by the heavier black down arrows. The three black dots represent repeat as necessary. The horizontal black arrow going to the right is when the driver presses “help”. The horizontal black arrow going to the left represents the driver selecting the button “back”. Going completely from top to bottom will guarantee the population of the entries constituting the customer preference table described earlier. The main difference is that this diagram incorporates the various help screens. If there is a need to have a more robust help facility, multiple help screens could be designed into this solution. Alternatively a vertical scroll bar could be instituted as an enhanced GUI navigational aid for the driver. The last GUI screen is really the end result of the embodiment of the invention. Instead of the engine warning light appearing on the dashboard, what will appear on the touch screen console is the concise representation the engine failing component, the minor component and the action made by the RTAOS. ⁷Refer to FIG. 51. ⁷ Refer to the engine light help URL

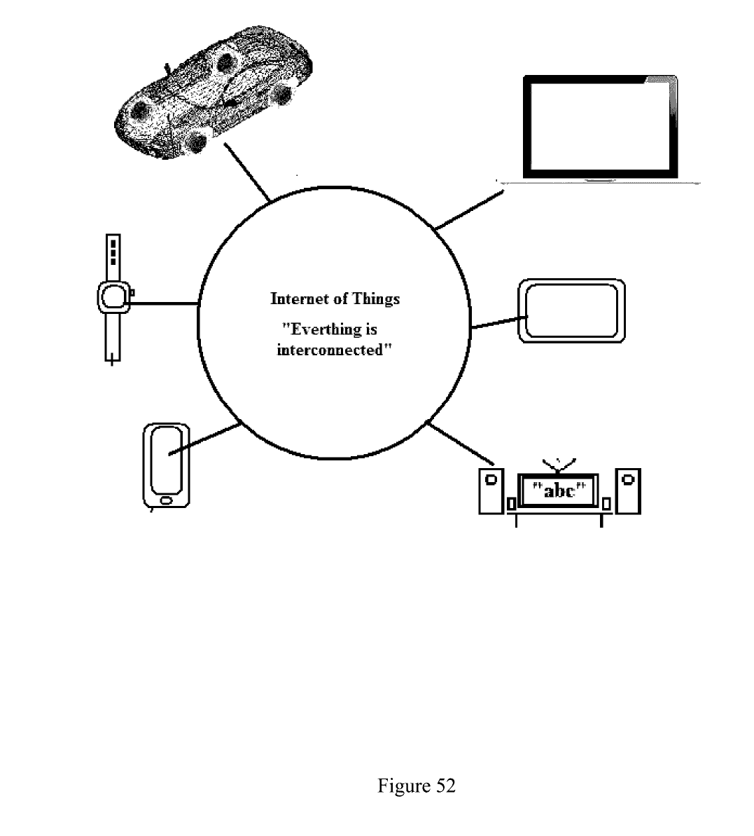

The last figure depicts the driver's car, laptop, smartphone, tablet, smart watch, infotainment center are all interconnected via the Internet. As more features for communication are enabled in the future, the driver will have more options to know the health of his/her automobile. From a very broad vision, one can envisage the Internet of Things (IOT), there is connectedness to all things belonging to the consumer and driver. With the pervasiveness of the Internet, the car, driver, dealer are finally connected. Refer to FIG. 52.

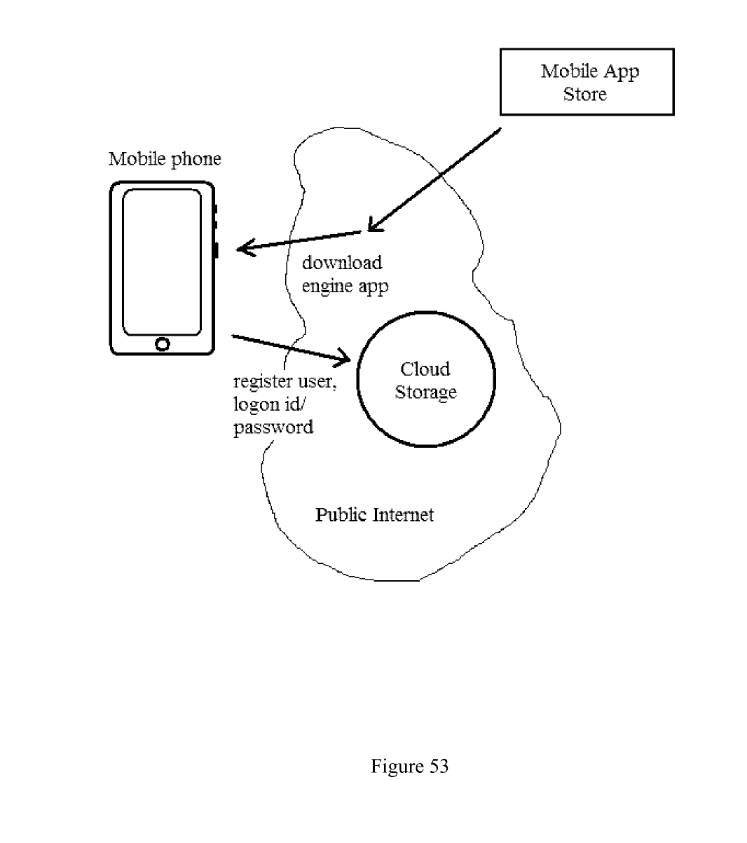

Since 2011 or more notably, in the last five years there has been an explosive growth of cloud computing and storage available for an economic way for innovative computer applications. Essentially, the cloud computing/storage vendor will provide a logical faceplate to an electronic condominium which is a time share service for all computer users. The public Internet will just become a networking facility no different than a dial-up telephone facility of more than 50 years ago, except this novelty transports data from the mobile device into the public Internet. This advent of novel applications has paved the way for mobile applications which allow for this invention to be unfettered to a desktop or personal computer. A driver can first download the mobile application onto his or her smartphone from the mobile app store via the public Internet. From there, the user can register the specific and unique logon id and an arbitrary robust password on the cloud based computing service. Refer to FIG. 53.

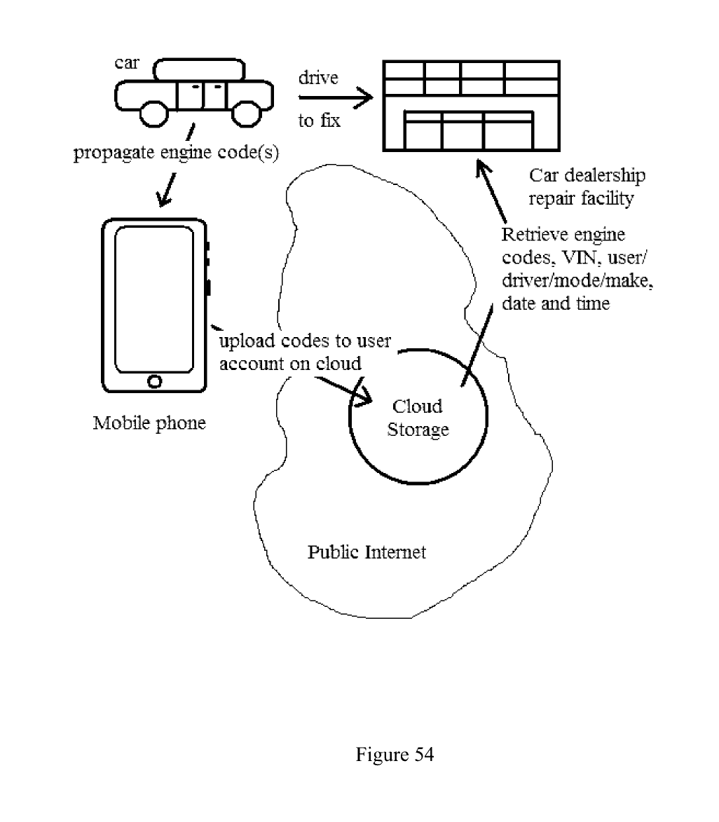

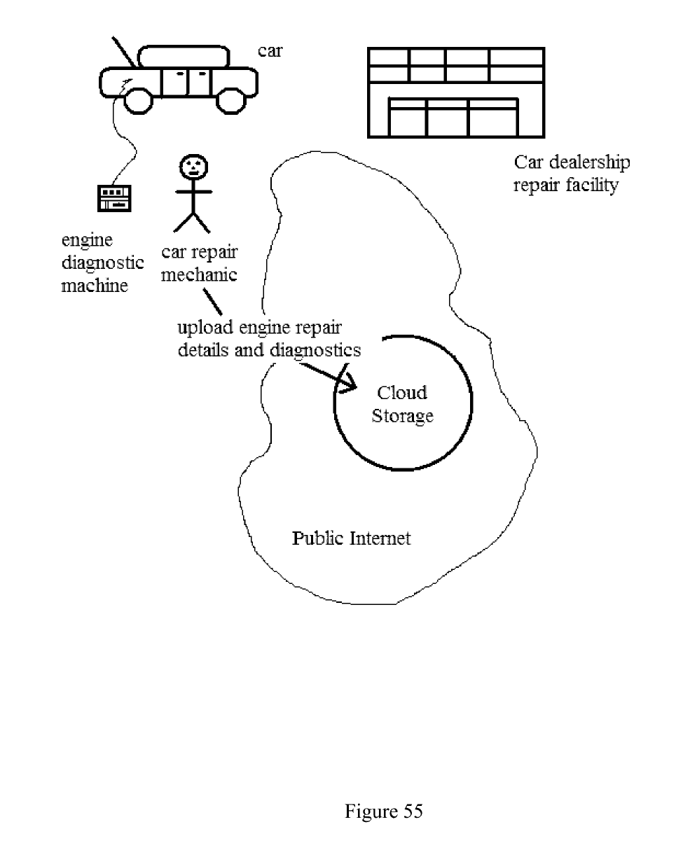

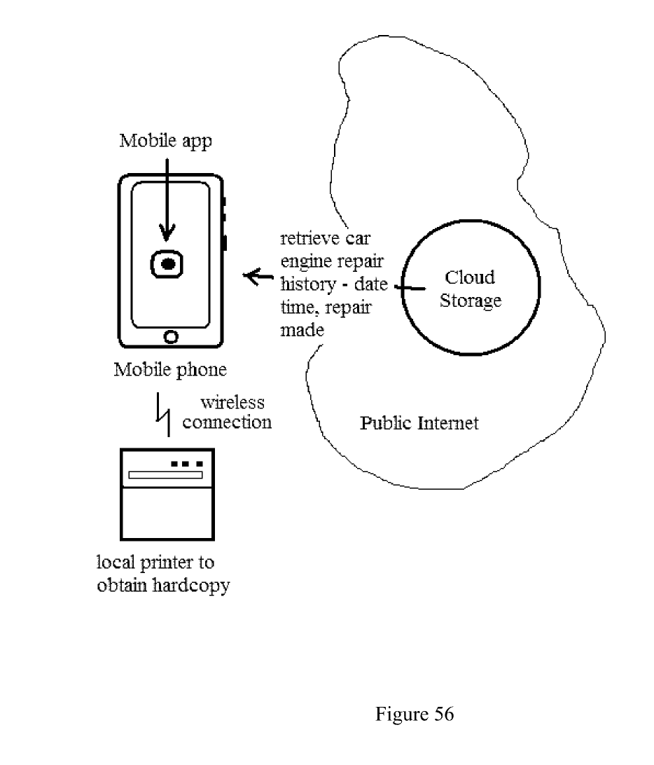

As the vehicle with the novelty is going through the normal routine of driving, should the engine code(s) emanate from the RTAOS system to the smartphone, there is crucial subsequent logical sequence which will happen. The engine codes and diagnostic messages will progagate from the smartphone onto the designated cloud storage and compute service. Following the daisy chain, the cloud compute service will then propagate the driver name, VIN number, car make and model and the specific engine code(s) and diagnostic messages, date and time of when these codes/messages first appeared on the driver vehicle. This valuable payload of information will go to the car dealership and repair facility. The last thing is for the driver to bring the vehicle to the repair facility to ascertain and have the car technician to validate the engine code(s) and rectify the engine problems at hand. Refer to FIG. 54. Upon successful resolution of the engine problems at hand, the car technician will upload to the cloud compute/storage service, the cause of engine codes to appear and what repairs were necessary including parts and labor. This completes the total roundtrip and feedback loop of this novelty. Refer to FIG. 55. The car driver has convenience of not having to retain any maintenance records in the future. With the mobile phone, the driver can easily summon any maintenance record of the engine and the specific and relevant disposition via the cloud compute/storage service. The driver can then download all the car repair service records and with a local wireless communications setup to a laser printer, can then get the hard copy of the complete history of the vehicle engine problems. Refer to FIG. 56.

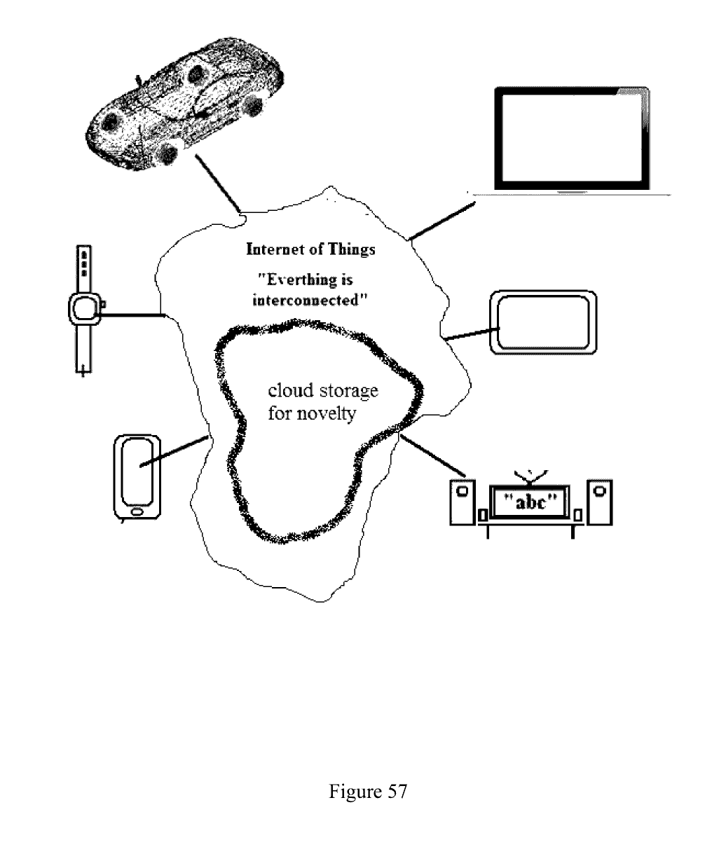

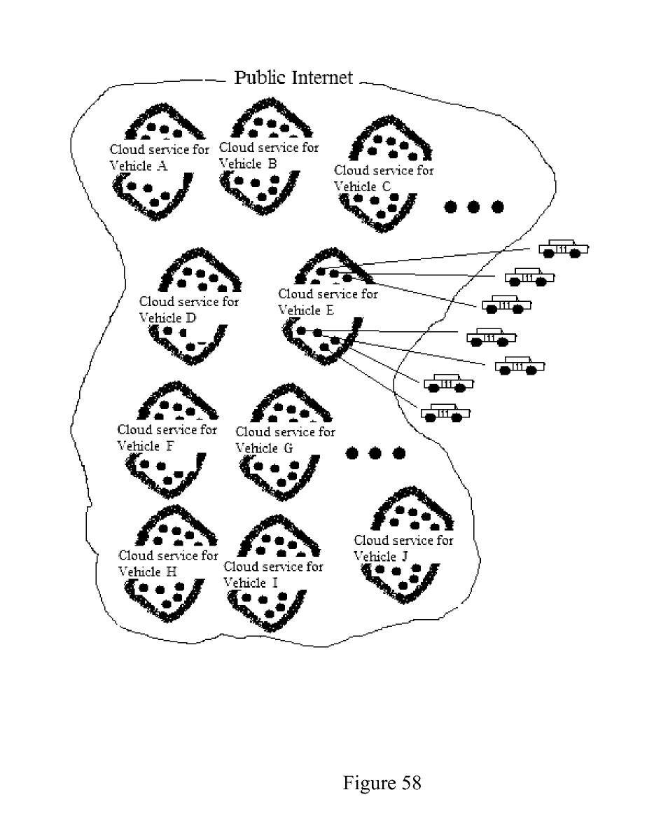

Thus, in the final analysis and logical summation of what is depicted in FIG. 52 which is the IoT and in FIG. 56 which is the smart phone access to the unique cloud storage is the universal access to the cloud storage. The driver has a wide range of devices, mobile no less, to have a complete digital dossier of the vehicle engine performance and service record. This is the vision and goal of this novel invention. Refer to FIG. 57. As the invention matures over time, the public Internet will be populated with cloud service offerings. There will be a separate cloud service offering for each car make. In FIG. 58, there are ten cloud service offerings for vehicle A, B, C, . . . , J. For vehicle E, there are seven cars logically connected to the cloud service offering. The two groupings of three solid black dots delineate more cloud service offerings. It is estimated there are several hundred car model and make combinations, all having their own unique set of engine codes and diagnostics. Ultimately, a Big Data application can be envisioned to tabulate numerically the frequency and severity of the type of engine problem by car model and make. In the future, the prospective car buyer will have some powerful and accurate repair metrics to make a more informed buying decision.

### The Advantageous Effects of Invention

The driver will know exactly what the engine problem is since there will be the means of conveying the messages onto the touchscreen console and the interior car stereo system. There will be all the engine codes stored in NVRAM. A database of customer vehicle engine codes can be accumulated over a period of time to analyze frequency of component failures. Eventually, the component failure database can be partitioned into different make and models.

1. This invention supersedes all known prior art of the engine warning light being displayed on the automobile dashboard, novelty of invention allows for a text-based visual presentation of the major engine problem and the minor engine problem. The automobile is a four wheeled vehicle, irrespective of domestic or foreign make and manufacturer. Included are trucks and buses which have more than 4 wheels. Oversized vehicles including SUVs, multi-passenger vans are included in this claim.

2. Based upon claim one, additional text based visual presentation includes the probable cause of the engine component problem or failure.

3. Based upon claims one and two, the text-based visual presentation includes a plan of action such as informing the driver's car dealer via text, email and/or automated phone call. This includes trucks and buses and any surface based, land based mode of vehicular transportation.

4. Claims one, two and three can be displayed on the instrument panel in front of the driver or on the center console with flat screen with touch capabilities or a head gear based heads up display via a hologram. This includes all surface and land based vehicles. Morever, the engine codes and diagnostic messages can be relayed from the RTAOS (real time automotive operating system) to the driver wearing a pair of smartglasses.

5. In addition to the text-based presentation of the engine problem, an audio presentation of the engine problem is made through the car stereo speaker system and via the Bluetooth ear piece which the car driver can wear.

6. The engine warning and diagnostic messages can be sent to the driver's tablet or smartphone or smart watch or an infotainment center via texting and email.

7. Based on claim one, the engine warning and diagnostic messages can be sent via the vehicle's emergency 24 by 7 channel and satellite phone channel

8. Based on claim one and claim five, the engine warning and diagnostic messages can be displayed and enunciated in French, Spanish, Russian, German, Italian and any character based language.

9. Said invention will be able to foster and promulgate a unique database of vehicle engine problems for further engineering improvements component fault isolation. The database primary key will be based upon the vehicle's VIN with columns for customer driver name, vehicle model, vehicle make, engine warning code, engine major code, engine minor code, time and day of engine anomaly. This information will provide an intelligent database of engine failure by engine component and the frequency and number of times a given engine component has failed. The auto repair facility can stock the more frequent engine components.

10. Said invention and novelty will store all engine code and diagnostic messages onto a public cloud based storage system for secure retrieval and archival purposes.
